(19) United States
(12) Patent Application Publication
(10) Pub. No.: US 2023/0147301 A1
(43) Pub. Date: May 11, 2023

(54) TECHNIQUES FOR INDICATING MEASUREMENT GAPS AND ASSOCIATING MEASUREMENT GAP PATTERNS WITH BANDWIDTH PART HOPPING PATTERNS

(71) Applicant: QUALCOMM INCORPORATED, SAN DIEGO (US)

(72) Inventors: Prashant Sharma, San Jose, CA (US); Changhwan Park, San Diego, CA (US); Iyab Issam Sakhnini, San Diego, CA (US); Tao Luo, San Diego, CA (US)

(21) Appl. No.: 17/454,519

(22) Filed: Nov. 11, 2021

(51) Int. Cl. H04W 72/08; H04W 72/04; H04L 5/00

(52) U.S. Cl. CPC H04W 72/085; H04W 72/044; H04L 5/0012; H04W 72/0406

(57) ABSTRACT

Methods, systems, and devices for wireless communications are described. A user equipment (UE) may indicate measurement gap information to a base station. For example, a UE may receive signaling configuring hopping patterns for multiple bandwidth parts (BWPs). Each BWP may include resource blocks having a bandwidth that is less than a threshold bandwidth support by the UE. The UE may transmit control signaling indicating measurement gap information for frequency spectrum bands, and the control signaling may indicate whether a measurement gap is applicable for measurements. The indication may be based on hopping patterns and a frequency-domain location of signals to be measured. The UE may determine a measurement gap pattern for an active BWP based on an association between the measurement gap pattern and the active BWP, or between the measurement gap pattern and a hopping pattern. The UE may perform measurements on signals based on the measurement gap pattern.

### FIELD OF TECHNOLOGY

The following relates to wireless communications, including techniques for indicating measurement gaps and associating measurement gap patterns with bandwidth part (BWP) hopping patterns.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). Some wireless communications systems may support reduced capability devices. Reduced capability devices (e.g., reduced capability UEs) may, in some cases, communicate on reduced bandwidths.

### SUMMARY

The described techniques relate to improved methods, systems, devices, and apparatuses that support techniques for indicating measurement gaps and associating measurement gap patterns with bandwidth part (BWP) hopping patterns. Generally, a user equipment (UE) may receive signaling configuring one or more hopping patterns for multiple BWPs. In some cases, each BWP may include resource blocks (RBs) having a bandwidth that is less than a threshold bandwidth support by the UE. In such cases, the UE may transmit control signaling to a base station that indicates measurement gap information for a set of frequency spectrum bands. In some examples, the control signaling may indicate whether a measurement gap is applicable (e.g., needed) for performing one or more signal measurements. In such examples, the indication may be based on the one or more hopping patterns and a frequency-domain location of the one or more signals to be measured. As a result, the indication of the measurement gaps requested for various BWP hopping patterns may provide for enhanced measurement procedures for the UE.

Additionally or alternatively, the UE may determine a measurement gap pattern for an active BWP based on an association between the measurement gap pattern and the active BWP, or an association between the measurement gap pattern and a hopping pattern, or any combination thereof. In such examples, the UE may perform measurements on one or more signals based on the determined measurement gap pattern. The association between the active BWP, the BWP hopping pattern, the measurement gap pattern, or any combination thereof, may enable a relatively greater number of measurement gap patterns for performing measurements by the UE for BWP hopping, while also providing efficient techniques for identifying measurement gap patterns. The present disclosure may therefore promote higher reliability and lower latency wireless communications, among other benefits.

A method for wireless communication at a UE is described. The method may include receiving signaling configuring one or more hopping patterns for a set of multiple BWPs, where each BWP of the set of multiple BWPs includes resource blocks having a bandwidth less than a threshold bandwidth support by the UE and transmitting, to a base station, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

An apparatus for wireless communication at a UE is described. The apparatus may include a processor, memory coupled with the processor, and instructions stored in the memory. The instructions may be executable by the processor to cause the apparatus to receive signaling configuring one or more hopping patterns for a set of multiple BWPs, where each BWP of the set of multiple BWPs includes resource blocks having a bandwidth less than a threshold bandwidth support by the UE and transmit, to a base station, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Another apparatus for wireless communication at a UE is described. The apparatus may include means for receiving signaling configuring one or more hopping patterns for a set of multiple BWPs, where each BWP of the set of multiple BWPs includes resource blocks having a bandwidth less than a threshold bandwidth support by the UE and means for transmitting, to a base station, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

A non-transitory computer-readable medium storing code for wireless communication at a UE is described. The code may include instructions executable by a processor to receive signaling configuring one or more hopping patterns for a set of multiple BWPs, where each BWP of the set of multiple BWPs includes resource blocks having a bandwidth less than a threshold bandwidth support by the UE and transmit, to a base station, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Some examples of the method, apparatuses, and non-transitory computer-readable medium described herein may further include operations, features, means, or instructions for identifying hopping pattern identifiers for each hopping pattern of the one or more hopping patterns and generating a hopping pattern identifier list including the hopping pattern identifiers for each hopping pattern, where the measurement gap information includes an indication of the hopping pattern identifier list.

Some examples of the method, apparatuses, and non-transitory computer-readable medium described herein may further include operations, features, means, or instructions for identifying indices for one or more frequency hops associated with the one or more hopping patterns and generating a hop index list including the indices for the one or more frequency hops, where the measurement gap information includes an indication of the hop index list.

Some examples of the method, apparatuses, and non-transitory computer-readable medium described herein may further include operations, features, means, or instructions for identifying one or more hop region identifiers corresponding to respective frequency-domain regions that include hops associated with the one or more hopping patterns, each frequency-domain region of the respective frequency-domain regions including indices for one or more frequency hops and generating a hop region list including the one or more hop region identifiers, where the measurement gap information includes an indication of the hop region list.

Some examples of the method, apparatuses, and non-transitory computer-readable medium described herein may further include operations, features, means, or instructions for identifying a separation frequency between respective hops of the one or more hopping patterns, where the measurement gap information includes an indication of the separation frequency between the respective hops.

Some examples of the method, apparatuses, and non-transitory computer-readable medium described herein may further include operations, features, means, or instructions for determining, for the set of one or more radio frequency spectrum bands, whether the measurement gap may be applicable for performing the one or more measurements, where the measurement gap information may be based on the determination.

Some examples of the method, apparatuses, and non-transitory computer-readable medium described herein may further include operations, features, means, or instructions for determining that the measurement gap may be not applicable for the set of one or more radio frequency spectrum bands, where the measurement gap information includes an indication that the measurement gap may be not applicable based on the determination that the measurement gap may be not applicable.

Some examples of the method, apparatuses, and non-transitory computer-readable medium described herein may further include operations, features, means, or instructions for receiving the signal from the base station and performing the one or more measurements of the signal based on the measurement gap information.

In some examples of the method, apparatuses, and non-transitory computer-readable medium described herein, the control signaling includes one or more information elements including the measurement gap information.

In some examples of the method, apparatuses, and non-transitory computer-readable medium described herein, the one or more measurements include intra-frequency measurements of a synchronization signal block and the measurement gap information includes intra-frequency measurement gap information.

In some examples of the method, apparatuses, and non-transitory computer-readable medium described herein, the one or more measurements include inter-frequency measurements of a synchronization signal block and the measurement gap information includes inter-frequency measurement gap information.

In some examples of the method, apparatuses, and non-transitory computer-readable medium described herein, the one or more measurements include reference signal received power (RSRP) measurements, reference signal received quality (RSRQ) measurements, signal-to-interference plus noise ratio (SINR) measurements, or any combination thereof.

A method for wireless communication at a UE is described. The method may include receiving signaling that configures one or more hopping patterns for each BWP of a set of multiple BWPs, where each BWP of the set of multiple BWPs includes resource blocks having a threshold bandwidth less than a bandwidth support by the UE, determining a measurement gap pattern for an active BWP based on an association between the measurement gap pattern and the active BWP, or an association between the measurement gap pattern and a hopping pattern from the one or more hopping patterns for the active BWP, or any combination thereof, and performing measurements on one or more signals based on the determined measurement gap pattern.

An apparatus for wireless communication at a UE is described. The apparatus may include a processor, memory coupled with the processor, and instructions stored in the memory. The instructions may be executable by the processor to cause the apparatus to receive signaling that configures one or more hopping patterns for each BWP of a set of multiple BWPs, where each BWP of the set of multiple BWPs includes resource blocks having a threshold bandwidth less than a bandwidth support by the UE, determine a measurement gap pattern for an active BWP based on an association between the measurement gap pattern and the active BWP, or an association between the measurement gap pattern and a hopping pattern from the one or more hopping patterns for the active BWP, or any combination thereof, and perform measurements on one or more signals based on the determined measurement gap pattern.

Another apparatus for wireless communication at a UE is described. The apparatus may include means for receiving signaling that configures one or more hopping patterns for each BWP of a set of multiple BWPs, where each BWP of the set of multiple BWPs includes resource blocks having a threshold bandwidth less than a bandwidth support by the UE, means for determining a measurement gap pattern for an active BWP based on an association between the measurement gap pattern and the active BWP, or an association between the measurement gap pattern and a hopping pattern from the one or more hopping patterns for the active BWP, or any combination thereof, and means for performing measurements on one or more signals based on the determined measurement gap pattern.

A non-transitory computer-readable medium storing code for wireless communication at a UE is described. The code may include instructions executable by a processor to receive signaling that configures one or more hopping patterns for each BWP of a set of multiple BWPs, where each BWP of the set of multiple BWPs includes resource blocks having a threshold bandwidth less than a bandwidth support by the UE, determine a measurement gap pattern for an active BWP based on an association between the measurement gap pattern and the active BWP, or an association between the measurement gap pattern and a hopping pattern from the one or more hopping patterns for the active BWP, or any combination thereof, and perform measurements on one or more signals based on the determined measurement gap pattern.

Some examples of the method, apparatuses, and non-transitory computer-readable medium described herein may further include operations, features, means, or instructions for identifying a hop duration associated with each of the one or more hopping patterns, where determining the measurement gap pattern may be based on the association between the measurement gap pattern, or the active BWP, or the hopping pattern for the active BWP, or the hop duration, or any combination thereof.

In some examples of the method, apparatuses, and non-transitory computer-readable medium described herein, determining the measurement gap pattern may include operations, features, means, or instructions for determining a first measurement gap pattern based on the active BWP, the hopping pattern for the active BWP, or any combination thereof, receiving an indication that the active BWP may be being modified from a first BWP to a second BWP different from the first BWP, and determining a second measurement gap pattern based on the second BWP, a second hopping pattern from the one or more hopping patterns for the second BWP, or any combination thereof.

In some examples of the method, apparatuses, and non-transitory computer-readable medium described herein, determining the measurement gap pattern may include operations, features, means, or instructions for determining a first measurement gap pattern based on the active BWP, the hopping pattern for the active BWP, or any combination thereof, receiving an indication that the hopping pattern for the active BWP may be being modified from a first hopping pattern to a second hopping pattern different from the first hopping pattern, and determining a second measurement gap pattern based on the second hopping pattern.

In some examples of the method, apparatuses, and non-transitory computer-readable medium described herein, determining the measurement gap pattern may include operations, features, means, or instructions for receiving signaling disabling the hopping pattern for the active BWP and determining a default measurement gap pattern based on the hopping pattern being disabled.

In some examples of the method, apparatuses, and non-transitory computer-readable medium described herein, the default measurement gap pattern may be associated with the active BWP.

Some examples of the method, apparatuses, and non-transitory computer-readable medium described herein may further include operations, features, means, or instructions for receiving an indication that the hopping pattern for the active BWP may be being modified from a first hopping pattern to a second hopping pattern different from the first hopping pattern, the second hopping pattern being associated with disabled BWP hopping, where the default measurement gap pattern may be associated with the second hopping pattern.

Some examples of the method, apparatuses, and non-transitory computer-readable medium described herein may further include operations, features, means, or instructions for identifying a measurement gap pattern identifier associated with the determined measurement gap pattern, where the measurement gap pattern identifier corresponds to a predetermined measurement gap pattern that excludes measurement gaps.

In some examples of the method, apparatuses, and non-transitory computer-readable medium described herein, determining the measurement gap pattern may include operations, features, means, or instructions for determining the measurement gap pattern based on an absence of the association between the measurement gap pattern and the active BWP, or the association between the measurement gap pattern and the hopping pattern from the one or more hopping patterns for the active BWP, or any combination thereof, where the determined measurement gap pattern excludes measurement gaps.

A method is described. The method may include transmitting signaling configuring one or more hopping patterns for a set of multiple BWPs, where each BWP of the set of multiple BWPs includes resource blocks having a bandwidth less than a threshold bandwidth support by a UE and receiving, from the UE, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

An apparatus is described. The apparatus may include a processor, memory coupled with the processor, and instructions stored in the memory. The instructions may be executable by the processor to cause the apparatus to transmit signaling configuring one or more hopping patterns for a set of multiple BWPs, where each BWP of the set of multiple BWPs includes resource blocks having a bandwidth less than a threshold bandwidth support by a UE and receive, from the UE, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Another apparatus is described. The apparatus may include means for transmitting signaling configuring one or more hopping patterns for a set of multiple BWPs, where each BWP of the set of multiple BWPs includes resource blocks having a bandwidth less than a threshold bandwidth support by a UE and means for receiving, from the UE, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

A non-transitory computer-readable medium storing code is described. The code may include instructions executable by a processor to transmit signaling configuring one or more hopping patterns for a set of multiple BWPs, where each BWP of the set of multiple BWPs includes resource blocks having a bandwidth less than a threshold bandwidth support by a UE and receive, from the UE, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

In some examples of the method, apparatuses, and non-transitory computer-readable medium described herein, receiving the control signaling indicating the measurement gap information may include operations, features, means, or instructions for receiving, as part of the measurement gap information, an indication of a hopping pattern identifier list including hopping pattern identifiers for each hopping pattern of the one or more hopping patterns.

In some examples of the method, apparatuses, and non-transitory computer-readable medium described herein, receiving the control signaling indicating the measurement gap information may include operations, features, means, or instructions for receiving, as part of the measurement gap information, an indication of a hop index list including indices for one or more frequency hops associated with the one or more hopping patterns.

In some examples of the method, apparatuses, and non-transitory computer-readable medium described herein, receiving the control signaling indicating the measurement gap information may include operations, features, means, or instructions for receiving, as part of the measurement gap information, an indication of a hop region list including one or more hop region identifiers corresponding to respective frequency-domain regions that include hops associated with the one or more hopping patterns, each frequency-domain region of the respective frequency-domain regions including indices for one or more frequency hops.

A method for wireless communications at a base station is described. The method may include transmitting signaling that configures one or more hopping patterns for each BWP of a set of multiple BWPs, where each BWP of the set of multiple BWPs includes resource blocks having a threshold bandwidth less than a bandwidth support by a UE and transmitting, to the UE, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof.

An apparatus for wireless communications at a base station is described. The apparatus may include a processor, memory coupled with the processor, and instructions stored in the memory. The instructions may be executable by the processor to cause the apparatus to transmit signaling that configures one or more hopping patterns for each BWP of a set of multiple BWPs, where each BWP of the set of multiple BWPs includes resource blocks having a threshold bandwidth less than a bandwidth support by a UE and transmit, to the UE, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof.

Another apparatus for wireless communications at a base station is described. The apparatus may include means for transmitting signaling that configures one or more hopping patterns for each BWP of a set of multiple BWPs, where each BWP of the set of multiple BWPs includes resource blocks having a threshold bandwidth less than a bandwidth support by a UE and means for transmitting, to the UE, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof.

A non-transitory computer-readable medium storing code for wireless communications at a base station is described. The code may include instructions executable by a processor to transmit signaling that configures one or more hopping patterns for each BWP of a set of multiple BWPs, where each BWP of the set of multiple BWPs includes resource blocks having a threshold bandwidth less than a bandwidth support by a UE and transmit, to the UE, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof.

Some examples of the method, apparatuses, and non-transitory computer-readable medium described herein may further include operations, features, means, or instructions for transmitting, to the UE, an indication that the active BWP may be being modified from a first BWP to a second BWP different from the first BWP, where a second measurement gap pattern may be based on the second BWP, a second hopping pattern from the one or more hopping patterns for the second BWP, or any combination thereof.

Some examples of the method, apparatuses, and non-transitory computer-readable medium described herein may further include operations, features, means, or instructions for transmitting signaling disabling the hopping pattern for the active BWP, where transmitting the one or more signals may include operations, features, means, or instructions for transmitting the one or more signals based on a default measurement gap pattern that may be associated with the hopping pattern being disabled.

In some examples of the method, apparatuses, and non-transitory computer-readable medium described herein, the default measurement gap pattern may be associated with the active BWP.

Some examples of the method, apparatuses, and non-transitory computer-readable medium described herein may further include operations, features, means, or instructions for transmitting an indication that the hopping pattern for the active BWP may be being modified from a first hopping pattern to a second hopping pattern different from the first hopping pattern, the second hopping pattern associated with disabled BWP hopping, where the default measurement gap pattern may be associated with the second hopping pattern.

### BRIEF DESCRIPTION OF THE DRAWINGS

FIGS. 1 and 2 each illustrate an example of a wireless communications system that supports techniques for indicating measurement gaps and associating measurement gap patterns with bandwidth part (BWP) hopping patterns in accordance with aspects of the present disclosure.

FIG. 3 illustrates an example of a narrow BWP (NBWP) hopping configuration that supports techniques for indicating measurement gaps and associating measurement gap patterns with BWP hopping patterns in accordance with aspects of the present disclosure.

FIG. 4 illustrates an example of measurement gap associations that supports techniques for indicating measurement gaps and associating measurement gap patterns with BWP hopping patterns in accordance with aspects of the present disclosure.

FIGS. 5 and 6 each illustrate an example of a process flow in a system that supports techniques for indicating measurement gaps and associating measurement gap patterns with BWP hopping patterns in accordance with aspects of the present disclosure.

FIGS. 7 and 8 show block diagrams of devices that support techniques for indicating measurement gaps and associating measurement gap patterns with BWP hopping patterns in accordance with aspects of the present disclosure.

FIG. 9 shows a block diagram of a communications manager that supports techniques for indicating measurement gaps and associating measurement gap patterns with BWP hopping patterns in accordance with aspects of the present disclosure.

FIG. 10 shows a diagram of a system including a device that supports techniques for indicating measurement gaps and associating measurement gap patterns with BWP hopping patterns in accordance with aspects of the present disclosure.

FIGS. 11 and 12 show block diagrams of devices that support techniques for indicating measurement gaps and associating measurement gap patterns with BWP hopping patterns in accordance with aspects of the present disclosure.

FIG. 13 shows a block diagram of a communications manager that supports techniques for indicating measurement gaps and associating measurement gap patterns with BWP hopping patterns in accordance with aspects of the present disclosure.

FIG. 14 shows a diagram of a system including a device that supports techniques for indicating measurement gaps and associating measurement gap patterns with BWP hopping patterns in accordance with aspects of the present disclosure.

FIGS. 15 through 20 show flowcharts illustrating methods that support techniques for indicating measurement gaps and associating measurement gap patterns with BWP hopping patterns in accordance with aspects of the present disclosure.

### DETAILED DESCRIPTION

Wireless communications systems may support communication links between wireless devices (e.g., such as a base station and a user equipment (UE)), such that wireless devices may communicate in various radio frequency spectrum bands. For example, a base station and a UE may operate over a carrier bandwidth. In some cases, a carrier bandwidth may be divided into multiple bandwidth parts (BWPs) that may be used for communication with a UE. Each BWP may include a contiguous set of resource blocks (RBs) on a carrier bandwidth and different BWPs may or may not be contiguous in frequency. For example, a BWP may be adjacent in frequency to another BWP or a BWP may have gaps or guard bands to adjacent BWPs. In some cases, BWPs may be configured with different properties (e.g., protocol features, numerologies, modulation schemes, physical channels). Further, a carrier may define one or more BWPs. For example, a New Radio (NR) carrier may define a number of BWPs (e.g., four or more BWPs), and each BWP may have a defined bandwidth and set of properties.

Some wireless communications systems may support reduced capability devices (e.g., UEs), which may be referred to as RedCap devices, RedCap UEs, or some similar terminology. Such devices (e.g., smart wearable devices, industrial sensors, or video surveillance devices) may operate with one or more of a reduced transmit power, a reduced number of transmit or receive antennas, a reduced transmit or receive bandwidth, or a reduced computational complexity. As such, some reduced capability UEs may implement narrow BWPs (NBWPs) to reduce BWP bandwidth and support complexity reduction features. Here, a NBWP may refer to a BWP having a bandwidth that is less than a threshold bandwidth. In some aspects, a NBWP may be referred to as a reduced BWP or some similar terminology. In some cases, a NBWP may have a bandwidth that is less than or equal to a bandwidth supported by some UEs (e.g., 100 megahertz (MHz)). In some cases, however, communication over narrower BWPs may be more susceptible to narrow band interference effects (e.g., interference due to narrower frequency constraints in which a UE may transmit or receive). Thus, to maintain network reliability and exploit frequency diversity gains, some UEs implementing NBWPs may further employ BWP frequency hopping (e.g., NBWP frequency hopping) techniques, such that a UE may switch from one BWP to another BWP while communicating with another device (e.g., a base station, another UE).

Some UEs implementing NBWPs (e.g., reduced capability devices) may perform one or more measurements (e.g., reference signal received power (RSRP), reference signal received quality (RSRQ), and signal-to-interference plus noise ratio (SINR) measurements) on signals received from the serving cell and neighboring cells. In some cases, the signals may be transmitted by the network on intra-frequency cells or inter-frequency cells. In cases where the frequency-domain location of the signal is different from the BWP in which the UE operating (e.g., the active BWP), the UE may utilize a measurement gap to allow time to retune a radio chain for performing measurements in a different band. As such, the UE may determine whether to use a measurement gap for measuring the signals based on the frequency-domain location of the signal. In some examples, the UE may be configured with a single measurement gap pattern for measuring the signal and, in some cases, the single measurement gap pattern may not be suitable for hopping patterns configured for the UE. Additionally or alternatively, the relative distance (e.g., in the frequency-domain) between the signal and the active BWP may change as the UE performs NBWP frequency hopping. Accordingly, mechanisms that enable the UE to indicate whether a measurement gap is to be used (e.g., needed, required, relied on, expected, preferred) for performing one or more measurements may be desirable.

As described herein, techniques for indicating measurement gaps and associating measurement gap patterns with BWPs and/or BWP hopping patterns may be used to enhance communications efficiency. For example, a measurement gap pattern may be associated with a hopping pattern such that, when the hopping pattern used by a UE changes, the measurement gap pattern used by the UE may also change.

Additionally or alternatively, the measurement gap pattern may be associated with an active BWP (e.g., NBWP) in which the UE is operating, and when the active BWP changes, the measurement gap pattern may also change. In some examples (e.g., if no association is defined or if hopping is disabled), the UE may perform measurements according to one or more default measurement gap patterns that may, for example, correspond to performing measurements without a measurement gap.

As further described herein, a UE may indicate, in addition to a list of frequencies in which the UE may perform measurements without a measurement gap, a list of hopping patterns (or hop indices) associated with a respective BWP. In such cases, a UE may indicate which hop indices (e.g., of each hopping pattern) may be measured without a measurement gap. More specifically, the UE may transmit an information element (IE) to a base station that indicates whether a measurement gap is required for certain BWP hopping patterns, or hop indices, or both, for the UE to perform measurements (e.g., intra-frequency measurements) of signals (e.g., reference signals, synchronization signal blocks (SSBs), or the like). In some aspects, the UE may indicate a hop region (e.g., an aggregate of one or more hop indices) and, in such cases, a UE may measure SSBs without a measurement gap if the SSBs occur within the hop region and may measure SSBs with a measurement gap if the SSBs occur outside the hop region.

Particular aspects of the subject matter described herein may be implemented to realize one or more potential advantages associated with techniques for indicating measurement gaps and associating measurement gap patterns with BWPs and/or BWP hopping patterns. For example, the described techniques may support efficient techniques for determining measurement gap patterns based on associations, which may be achieved without increasing signaling overhead between a UE and base station. In addition, the signaling of whether a measurement gap is needed for different hopping patterns (e.g., via capability signaling) may enable improved intra- and inter-frequency measurement processes. Such techniques may result in relatively higher data rates, greater UE and network capacity, and greater spectral efficiency.

Aspects of the disclosure are initially described in the context of wireless communications systems. Aspects of the disclosure are also described in the context of a NBWP hopping configurations, measurement gap associations, and process flows that support techniques for indicating measurement gaps and associating measurement gap patterns with BWP hopping patterns. Aspects of the disclosure are further illustrated by and described with reference to apparatus diagrams, system diagrams, and flowcharts that relate to techniques for indicating measurement gaps and associating measurement gap patterns with BWP hopping patterns.

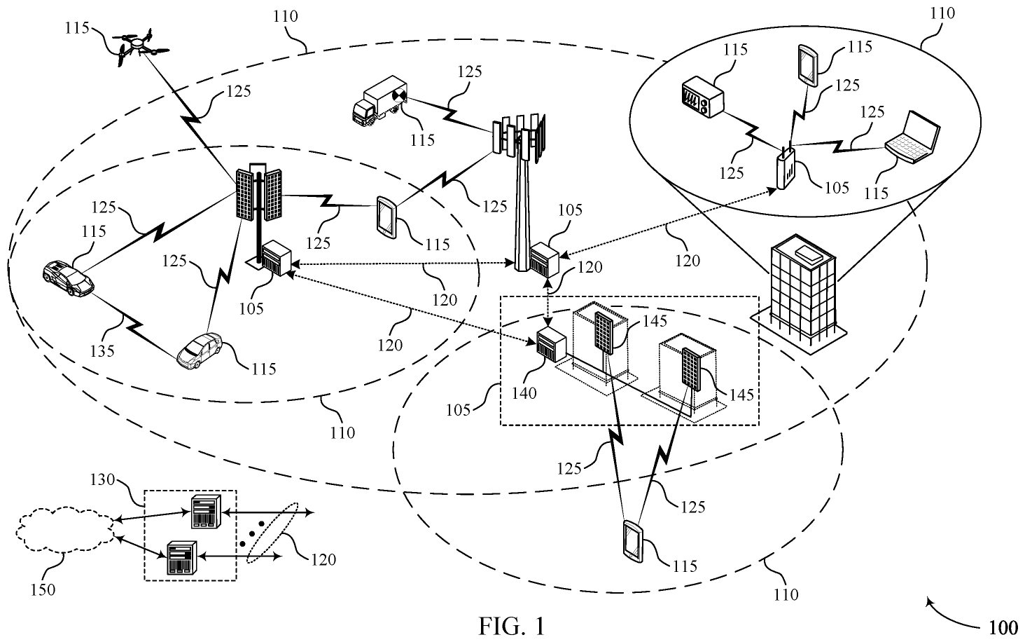

FIG. 1 illustrates an example of a wireless communications system 100 that supports techniques for indicating measurement gaps and associating measurement gap patterns with BWP hopping patterns in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may provide a UE 115 with a measurement reporting configuration, for example, as part of a radio resource control (RRC) configuration. The measurement reporting configuration may include parameters related to which neighbor cells and frequencies the UE 115 should measure, criteria for sending measurement reports, intervals for transmission of measurement reports (e.g., measurement gaps), and other related information. In some cases, measurement reports may be triggered by events related to the channel conditions of the serving cells or the neighbor cells. For example, a first report (A1) may be triggered when the serving cell becomes better than a threshold; a second report may be triggered when the serving cell becomes worse than a threshold; a third report when a neighbor cell becomes better than the primary serving cell by an offset value; a fourth report when a neighbor cell becomes better than a threshold; a fifth report when a primary serving cell becomes worse than a threshold and a neighbor cell is simultaneously better than another (e.g., higher) threshold; a sixth report when a neighbor cell becomes better than a secondary serving cell by an offset value; a seventh report when a neighbor using a different radio access technology (RAT) becomes better than a threshold; and an eighth report when a primary serving cell becomes worse than a threshold and the inter-RAT neighbor becomes better than another threshold. In some cases, the UE 115 may wait for a timer interval known as time-to-trigger (TTT) to verify that the trigger condition persists before sending the report. Other reports may be sent periodically instead of being based on a trigger condition (e.g., every two seconds a UE 115 may transmit an indication of a transport block error rate). Other measurement reports may be configured for the UE 115, where a measurement configuration may include one or more measurement objects for measurement by the UE 115. In some cases, a UE 115 may measure SSBs, reference signal, or other types on signals on inter-frequency bands or intra-frequency bands.

The wireless communications system 100 may support one or more aspects of techniques for indicating measurement gaps and associating measurement gap patterns with BWP hopping patterns. For example, the UE 115 may receive signaling configuring one or more hopping patterns for multiple BWPs. In some cases, each BWP may include RBs having a bandwidth that is less than a threshold bandwidth support by the UE 115. In such cases, the UE 115 may transmit control signaling (e.g., RRC signaling, one or more information elements (IEs), or the like) to the base station 105 that indicates measurement gap information for a set of frequency spectrum bands. In some examples, the control signaling may indicate whether a measurement gap is applicable (e.g., needed) for performing one or more signal measurements. The indication may be based on the one or more hopping patterns and a frequency-domain location of the signal for the one or more measurements.

The wireless communications system 100 may support techniques for determining measurement gap patterns for an active BWP (e.g., an active NBWP) based on an association between the measurement gap pattern and the active BWP, or an association between the measurement gap pattern and a hopping pattern, or any combination thereof. In such examples, a UE 115 may perform measurements on one or more signals based on the determined measurement gap pattern. The association between the active BWP, the BWP hopping pattern, the measurement gap pattern, or any combination thereof, may enable a relatively greater number of measurement gap patterns for performing measurements by the UE 115 for BWP hopping, while also providing efficient techniques for identifying measurement gap patterns. The present disclosure may therefore promote higher reliability and lower latency wireless communications, among other benefits.

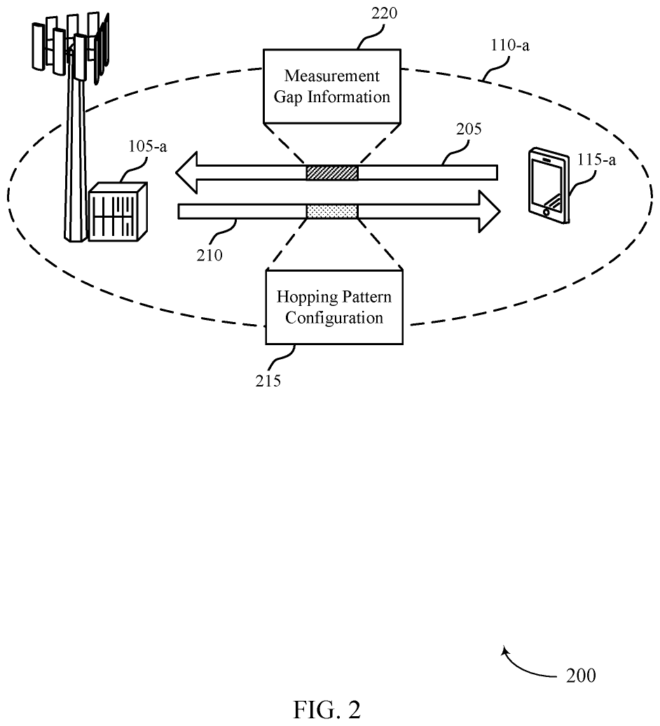

FIG. 2 illustrates an example of a wireless communications system 200 that supports techniques for indicating measurement gaps and associating measurement gap patterns with BWP hopping patterns in accordance with aspects of the present disclosure. The wireless communications system 200 may implement or be implemented by aspects of the wireless communications system 100. For example, the wireless communications system 200 may include a base station 105-a and a UE 115-a, which may be examples of the corresponding devices described with reference to FIG. 1. The base station 105-a and the UE 115-a may communicate via a communication link 205 (e.g., an uplink) and a communication link 210 (e.g., a downlink) in a geographic coverage area 110-a, which may be an example of a geographic coverage area 110 described with reference to FIG. 1. In some cases, the UE 115-a may perform one or more signal measurements across one or more frequencies of a BWP (e.g., or multiple BWPs) used for communications between the UE 115-a and the base station 105-a.

The wireless communications system 200 may support relatively reduced capability devices. For instance, the UE 115-a may support one or more complexity reduction features to reduce power consumption, such as relatively reduced bandwidth communications (e.g., relatively narrow bandwidth communications). In some cases, a relatively reduced capability may be associated with a form factor of the device, a design of the device, a configured function of the device, or the like. For example, suitable data rates for reduced capability devices (e.g., the UE 115-a) may be achieved with bandwidths less than 100 MHz). In some cases, the UE 115-a may support a bandwidth less than 100 MHz both during and after initial access. As such, the UE 115-a may operate in a NBWP to save power. Stated alternatively, to reduce the bandwidth, and thus to save power, the UE 115-a may operate in a relatively narrow (e.g., less than 100 MHz) bandwidth active BWP (e.g., a NBWP).

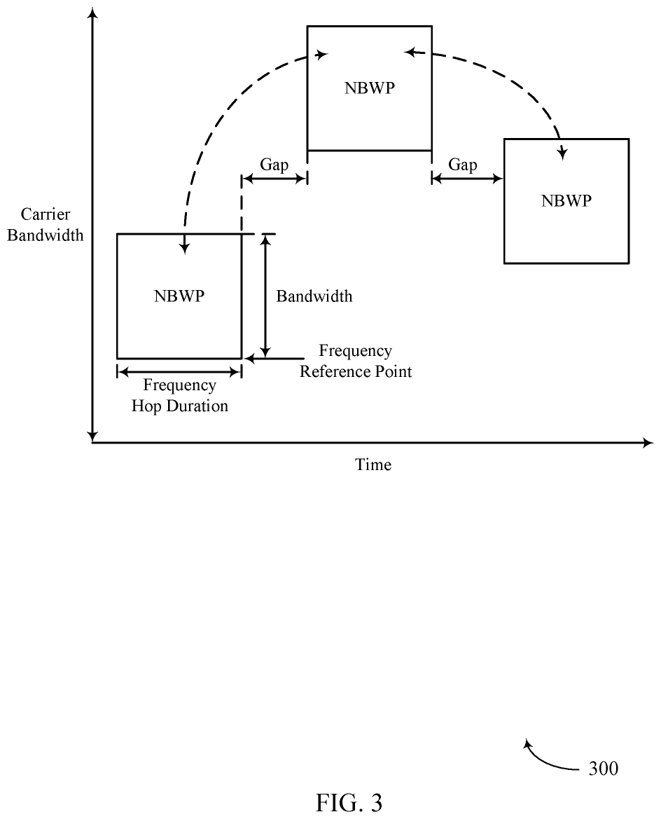

Due to the reduced bandwidth of an active BWP, it may be desirable to reduce narrow band interference effects and exploit (e.g., achieve) frequency diversity gains. For example, the UE 115-a may utilize NBWP frequency hopping techniques. In some cases, during NBWP frequency hopping, time and frequency resources within the BWP (e.g., the active NBWP) may be relative to a reference point within the BWP frequency hop that does not change. In other words, the UE 115-a may hop between one or more NBWPs within a carrier bandwidth (e.g., or across the carrier bandwidths) while performing wireless communications to improve diversity gain. The NBWPs also may be referred to as BWPs or frequency hops. NBWP frequency hopping is described in further detail elsewhere herein, including with reference to FIG. 3. In some cases, procedures for wireless communications may be transparent to frequency hopping between the NBWPs. Such procedures may include hybrid automatic repeat request (HARD) procedures, timers, and grants, among other examples.

The UE 115-a may hop between one or more frequency hops according to a NBWP hopping pattern. A NBWP hopping pattern may be referred to as a frequency hopping pattern or a hopping pattern. In some cases, one or more hopping patterns may be indicated to the UE 115-a (e.g., via control signaling) or, in some other case, one or more hopping patterns may be configured at the UE 115-a. The hopping pattern may indicate (e.g., define) a duration of each frequency hop in the hopping pattern (e.g., a frequency hop duration), a periodicity associated with the frequency hops, one or more BWP resources, a gap period, or a combination thereof. In some examples, the frequency hop duration may be configured for the UE 115-a in accordance with one or more parameters, such as conditions of a channel between the UE 115-a and the base station 105-a. The frequency hop duration may be the same or different for each frequency hop within a hopping pattern or across different hopping patterns.

The UE 115-a may perform measurements, such as reference signal received power (RSRP) measurement, reference signal received quality (RSRQ) measurement, SINR measurement, or any combination thereof, on one or more signals (e.g., SSBs) transmitted from a serving cell (e.g., the base station 105-a) as well as from inter-frequency and intra-frequency neighboring cells (e.g., other base stations 105, not shown). In some cases, the UE 115-a may utilize measurement gaps to identify and measure SSBs transmitted from inter-frequency and intra-frequency neighboring cells. In some examples, the network (e.g., the base station 105-a or another network entity) may configure the UE 115-a with a single measurement gap pattern, or a single measurement gap pattern per frequency range (e.g., a pattern for FR1 and a pattern for FR2), based on the capability of the UE. In some cases, the measurement gap pattern may be associated with a gap pattern identifier (e.g., ID) and may correspond to a measurement gap configuration. A measurement gap configuration may include a measurement gap length (MGL) as well as a measurement gap repetition period (MGRP) as illustrated in the following Table 1:

TABLE 1

| | Measurement Gap | Measurement Gap Repetition |
|---|---|---|
| Gap Pattern ID | Length (MGL, ms) | Period (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |
| 24 | 10 | 80 |
| 25 | 20 | 160 |

In some examples, however, a measurement gap pattern that may be suitable for one hopping pattern may not be suitable for one or more other hopping patterns configured for the UE 115-a. In particular, some measurement gap patterns may not account for intra- or inter-frequency measurements that result from different BWPs associated with different hopping patterns. Additionally or alternatively, the network may dynamically change (e.g., reconfigure) the hopping pattern of the UE 115-a according to network conditions, channel conditions, or changes in measurements to be performed on signals transmitted from neighboring cells (e.g., due to changes in channel conditions). Therefore, it may be desirable for the UE 115-a to use a measurement gap pattern that is suitable for the hopping pattern actively used by the UE 115-a. Stated alternatively, the network may increase resource utilization by configuring the UE 115-a with a suitable measurement gap pattern based on the hopping pattern of the UE 115-a, such as when the UE 115-a is actively performing NBWP hopping. Accordingly, a different (e.g., separate) measurement gap pattern may be used for different NBWPs or different hopping patterns.

For example, the UE 115-a may receive signaling (e.g., a hopping pattern configuration 215) configuring one or more hopping patterns for multiple BWPs. In some cases, each BWP may include RBs having a bandwidth that is less than or equal to a threshold bandwidth support by the UE 115-a (e.g., may be a NBWP). In some cases, the UE 115-a may determine a measurement gap pattern for an active BWP (e.g., an active NBWP) based on an association between the measurement gap pattern and the active BWP, or between the measurement gap pattern and a hopping pattern. In such examples the UE 115-a may perform measurements on one or more signals (e.g., one or more SSBs) based on the measurement gap pattern.

Additionally or alternatively, the UE 115-a may perform inter-frequency or intra-frequency measurements without a measurement gap. For example, in some cases, the SSB may be contained in the active NBWP of the UE 115-a and, therefore, the UE 115-a may perform the SSB measurement without a measurement gap. Therefore, the UE 115-a may indicate to the base station 105-a whether a measurement gap may be applicable for performing measurements based on various hopping patterns. For example, the UE 115-a may receive signaling configuring one or more hopping patterns for multiple BWPs. In some cases, each BWP may include RBs having a bandwidth that is less than a threshold bandwidth support by the UE 115-a. In such cases, the UE 115-a may transmit control signaling, to the base station 105-a, indicating measurement gap information (e.g., measurement gap information 220) for a set of frequency spectrum bands. In some examples, the control signaling may indicate whether a measurement gap may be applicable for performing one or more signal measurements (e.g., RSRP, RSRQ, or SINR). In such examples, the indication may be based on the one or more hopping patterns and a frequency-domain location of the one or more signals (e.g., SSBs) to be measured.

FIG. 3 illustrates an example of a NBWP hopping configuration 300 that supports techniques for indicating measurement gaps and associating measurement gap patterns with BWP hopping patterns in accordance with aspects of the present disclosure. The NBWP hopping configuration 300 may implement or may be implemented by aspects of the wireless communications system 100 or the wireless communications system 200. For example, the NBWP hopping configuration 300 illustrates an example configuration of NBWPs (which may also be referred to as frequency hops) supported by a UE 115 for communications with a base station 105 or some other device or network entity. As such, the NBWP hopping configuration 300 may be an example of a NBWP hopping configuration. The UE 115 and the base station 105 may be examples of the corresponding devices described with reference to FIGS. 1 and 2.

The NBWPs illustrated in the NBWP hopping configuration 300 may be located at different frequencies in the carrier bandwidth. A UE (e.g., a UE 115, not shown) may remain in a first NBWP for a time period (e.g., a frequency hop duration) before hopping to another set of frequency resources of another NBWP for a second time period. The UE 115 may continue to hop between NBWPs to improve frequency diversity gain. Each NBWP may include different time and frequency resources that may be relative to a reference point within the NBWP that may not change. For example, the frequency resources within a NBWP may be relative to a frequency reference point (e.g., a lowest frequency in the NBWP) or some other frequency reference point. The time resources within the NBWP may be relative to a time reference point (e.g., a starting time of the NBWP) or some other reference point in the time domain.

Each NBWP may be associated with a respective frequency hop duration. In some examples, the frequency hop duration for each NBWP may be the same and, in some other examples, each NBWP may be associated with a different frequency hop duration. The frequency hop duration for a NBWP may, in some cases, may be configured (e.g., signaled) to the UE 115, or selected by the UE 115 in accordance with one or more parameters. For example, the UE 115 may select a frequency hop duration based on channel conditions associated with a channel between the UE 115 and a base station 105 (not shown).

The UE 115 may switch between NBWPs according to one or more random, pseudo-random, or fixed hopping patterns. The UE 115 may perform hopping during a gap period. The gap may provide for the UE 115 to perform radio frequency (RF) retuning to support the switch between frequencies (e.g., frequency hop). As described with reference to FIG. 2, the UE 115 may perform measurements of an SSB within one or more of the NBWPs. If the SSB to be measured by the UE 115 is scheduled outside of a NBWP in which the UE 115 currently receives data, the UE 115 may switch to a second NBWP that includes the SSB to perform the measurement. Therefore, in some cases, a gap period for the UE 115 to switch between NBWPs may occur during the measurement.

In some examples, the UE 115 may perform inter-frequency or intra-frequency measurements without a gap period. For example, the UE may perform intra-frequency measurements without a measurement gap if the SSB to be measured is within an active BWP of the UE 115. That is, if the UE 115 receives data and the SSB within the active BWP, the UE 115 may receive data and the SSB on a same frequency hop. In another example, a UE 115 may perform intra-frequency measurement without a gap if the UE 115 transmits signaling including an IE (which may be referred to as an instruction element) for intra-frequency measurement. For example, the UE 115 may transmit and indication (e.g., no-gap) using a field of an IE (e.g., a gapindicationIntra field or a gapindication field within a NeedForGapsInfo IE), which indicates, for the UE 115, the measurement gap requirement information for intra-frequency measurements (e.g., with measurement gaps, without measurement gaps). In yet another example, the UE may perform intra-frequency measurement without a gap if the SSB is contained within an active BWP (e.g., an active NBWP) of the UE 115 or if the active NBWP is an initial BWP. Additionally or alternatively, the UE 115 may perform inter-frequency measurement without a gap if the UE 115 indicates support for inter-frequency measurements without gaps and if the SSB is contained within the active BWP of the UE 115. The UE 115 may indicate support for inter-frequency measurements without gaps by setting an indication in a field of an IE (e.g., interFrequencyConfig-NoGap or interFrequencyMeas-Nogap field within the IE).

In some examples, the UE 115 may indicate, to the base station 105, one or more parameters (e.g., fields) associated with the measurement gap, for instance via an IE (e.g., via a NeedForGapsConfig or NeedForGapsInfo IE). For example, the UE 115-a may indicate a serving cell identifier (e.g., servCellId) associated with the SSB to be measured (e.g., the SSB associated with the initial downlink BWP). In some cases, the UE 115 may further indicate whether the associated SSBs may be measured with or without a gap via an IE field, such as a gapindicationIntra field. In another example, the UE 115 may indicate a target band identifier (e.g., band) associated with the target band (e.g., a target NR band) to be measured. In some cases, the UE 115 may further indicate whether SSBs associated with the target band identifier may be measured without a gap via an IE field, such as gapindication.

The UE 115 may determine whether to indicate the applicability of a measurement gap based on one or more parameters. For example, the UE may determine whether to indicate no-gap via the intraFreq-needForGap field for intra-frequency measurement or via the interFrequencyConfig-NoGap field for inter-frequency measurements based on, among other parameters, whether the UE may perform the measurement without radio frequency retuning. In some cases, the UE 115 may indicate whether a measurement gap is to be used (e.g., needed, required, or preferred) for performing one or more measurements based on the implementation of the UE 115 and the distance (e.g., in frequency) between the SSB to be measured and the active BWP (e.g., active NBWP) of the UE 115. As such, the UE 115 may indicate measurement gap information which may include a list of frequencies or frequency bands for which a measurement gap may not be applicable (e.g., needed, required, or preferred). In some cases, the UE 115 may indicate measurement gap information via an IE, such as via a NeedForGapsBandlist field of an IE.

However, the relative distance (e.g., in the frequency-domain) between the SSB to be measured and the active NBWP of the UE 115 may change as the UE 115 performs NBWP frequency hopping. Therefore, in some cases, an intra-frequency carrier or an inter-frequency carrier containing an SSB configured for measurement may lie within a short frequency separation from the active NBWP and, in some other cases, the intra-frequency carrier or the inter-frequency carrier may not lie within a short frequency separation from the active NBWP. Accordingly, the UE 115 may indicate that a measurement gap may not be applicable for frequencies or frequency bands in which a measurement gap may be applicable. Similarly the UE 115 may refrain from indicating that a measurement gap may not be applicable for frequencies or frequency bands in which a measurement gap may not be applicable. Stated alternatively, the UE 115 may not indicate no-gap via the intraFreq-needForGap IE (e.g., for intra-frequency measurements) or may not set the interFrequencyMeas-Nogap to interFrequencyConfig-NoGap (e.g., for inter-frequency measurements) for one or more frequencies or one or more frequency bands in which measurements may be performed without a gap.

Therefore, it may be desirable to define criteria for determining whether the UE 115 (e.g., a UE operating with NBWP hopping) may indicate no-gap via the intraFreq-needForGap field in the case of intra-frequency measurements and set the interFrequencyMeas-Nogap-IE to InterFrequencyConfig-NoGap in the case of inter-frequency measurements. For example, the UE 115 may indicate, within an IE, one or more identifiers associated with a hopping pattern in which a measurement gap may not be applicable (e.g., needed). In some cases, the identifiers may include a hopping pattern identifier (e.g., nbwp-HoppingPatternId), a hop index identifier (e.g., nbwp-HopIndex), or a hop region identifier (e.g., nbwp-HopRegion). In some instances, one or more hop index identifiers and one or more hop region identifiers may be indicated via an IE. For example, a hop index list IE (e.g., the NBWPHopIndexList) and a hop region list in the IE (e.g., the NBWPHopRegionList) may be used to indicate one or more hop index identifiers and one or more hop region identifiers, respectively. In some cases, the UE 115 may indicate the one or more identifiers (e.g., or the one or more lists of identifiers) with the list of frequencies or frequency bands in the measurement gap information. Stated alternatively, the UE 115 may indicate no-gap for one or more hopping patterns, one or more indices, or one or more hop regions with a one-to-may mapping via an IE, such as within a NB WPHoppingPatternIDList field. In some examples, a hop region may refer to a combination of multiple hop indices. In some cases, the UE 115 may use the frequency separation (e.g., a separation frequency) between the hops to determine whether a measurement gap may be applicable. It is to be understood that the names of IEs described herein may change based on implementation of one or more devices (e.g., the UE 115, the base station 105, or both), and the examples described herein should not be considered limiting to the scope covered by the claims or the disclosure.

Thus, the UE 115 and the base station 105 may support techniques for indicating measurement gaps and associating measurement gap patterns with BWP hopping patterns. For example, the UE 115 may transmit control signaling, to the base station 105, indicating (e.g., for a set of frequencies or frequency bands) whether a measurement gap may be applicable for performing one or more signal measurements. Additionally or alternatively, the UE 115 may determine a measurement gap pattern for an active BWP based on an association between the measurement gap pattern and the active BWP, or between the measurement gap pattern and a hopping pattern. The present disclosure may therefore promote higher reliability and lower latency wireless communications, among other benefits.

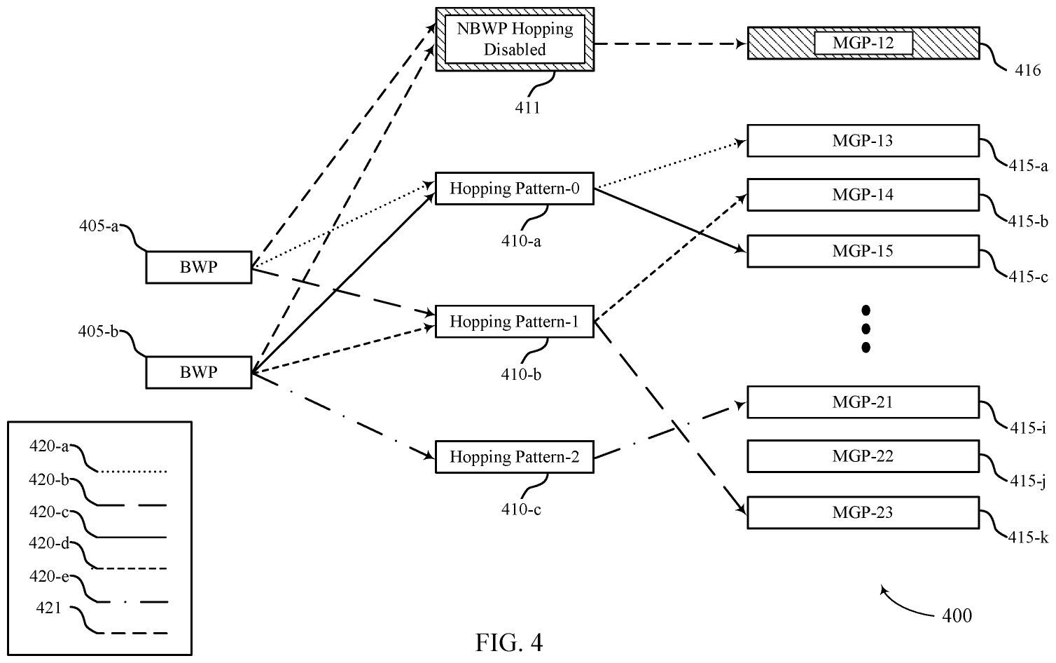

FIG. 4 illustrates an example of measurement gap associations 400 that supports techniques for indicating measurement gaps and associating measurement gap patterns with BWP hopping patterns in accordance with aspects of the present disclosure. The measurement gap associations 400 may implement or may be implemented by aspects of the wireless communications systems 100 and 200. For example, systems that support the mapping illustrated by the measurement gap associations 400 may be implemented by a base station 105 and a UE 115, which may be examples of the corresponding devices described with reference to FIGS. 1 and 2. Further, systems which support the mapping illustrated by the measurement gap associations 400 may include one or more BWPs 405, and one or more hopping patterns 410, and one or more measurement gap patterns 415 (e.g., MGPs). A measurement gap pattern 415, a hopping pattern 410, and a BWP 405, may be examples of the corresponding aspects described throughout the application, including with reference to FIGS. 2 and 3.

As illustrated in the example of FIG. 4, one or more measurement gap patterns 415 (e.g., measurement gap patterns 415-a through 415-k) may be associated with one or more BWPs 405 (e.g., BWP 405-a, BWP 405-b), one or more hopping patterns 410 (e.g., hopping patterns 410-a through 410-c), one or more frequency hop durations, or a combination thereof. For example, a measurement gap pattern 415-a may be associated with a hopping pattern 410-a and a BWP 405-a via an association 420-a. In some cases, one or more associations 420 may be defined via a NBWP identifier (e.g., NBWP id) and a hopping pattern identifier (e.g., HoppingPattern_id). That is, one or more IE fields, such as NBWP id and HoppingPattern_id, may be used to determine a measurement gap pattern identifier (e.g., MGPattern_id) for a UE (e.g., the UE 115). In some examples, such an association (e.g., one or more associations 420) may trigger the measurement gap to change when the active BWP of the UE 115 changes, or the hopping pattern actively used by the UE changes.

For example, the active NBWP of the UE 115 may be the BWP 405-a. In such an example, the UE 115 may be performing NBWP hopping according to the hopping pattern 410-a and may be performing SSB-based measurements according to the measurement gap pattern 415-a. However, in some cases, the active NBWP of the UE 115-a may change from the BWP 405-a to a different BWP (e.g., a BWP 405-b). In such cases, an association between the measurement gap pattern 415-a and the BWP 405-a may not be defined and, as such, the measurement gap pattern of the UE 115 may change. For instance, measurement gap pattern 415-c may be associated with the BWP 405-b and the hopping pattern 410-a in accordance with association 420-d, and the UE 115 may accordingly use the measurement gap pattern 415-c when the BWP 405-a is modified to the BWP 405-b.

In some other examples, the hopping pattern 410 for a BWP 405 may be modified. As an example, when an active BWP 405 of the UE 115 is the BWP 405-a, the hopping pattern 410-a may be modified to the hopping pattern 410-b or the hopping pattern 410-c. Similarly, BWP 405-b may be associated with hopping patterns 410-a, 410-b, and/or 410-c (and/or associated with measurement gap patterns 415) via respective associations 420. In some cases, the use of the BWP 405-a as the active BWP and the configured hopping pattern 410-b may enable a UE 115 to determine, via association 420-b, that measurement gap pattern 415-k may be used for measurements. In another example, the use of the BWP 405-b as the active BWP and the use of hopping pattern 410-c, may enable the UE 115 to use measurement gap pattern 415-I (e.g., via association 420-e) for one or more measurements.

Additionally or alternatively, in the case where hopping pattern 410-c is configured when the BWP 405-a is the active BWP, there may be no defined association between the BWP 405, the hopping pattern 410, and a measurement gap pattern. In such examples, if an association between a measurement gap pattern and a BWP (e.g., or a measurement gap pattern and a hopping pattern) is not defined, a default measurement gap pattern may be used. Stated alternatively, a default pattern may be used by the UE 115 in the absence of an association between a measurement gap and a BWP or a hopping pattern. For instance, a different default measurement gap pattern may be configured for each NBWP (e.g., each BWP 405).

In some other examples, the UE 115 may use a default measurement gap pattern when a hopping pattern is disabled. For instance, a hopping pattern (e.g., a hopping pattern 411) may be associated (e.g., via an association 421) with disabled NBWP hopping and the associated measurement gap pattern (e.g., a measurement gap pattern 416) may be a default measurement gap pattern.

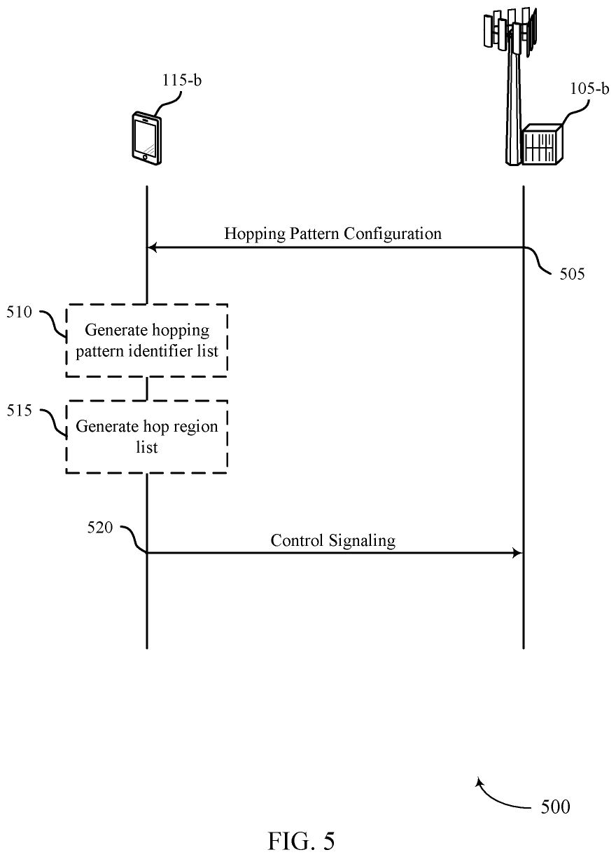

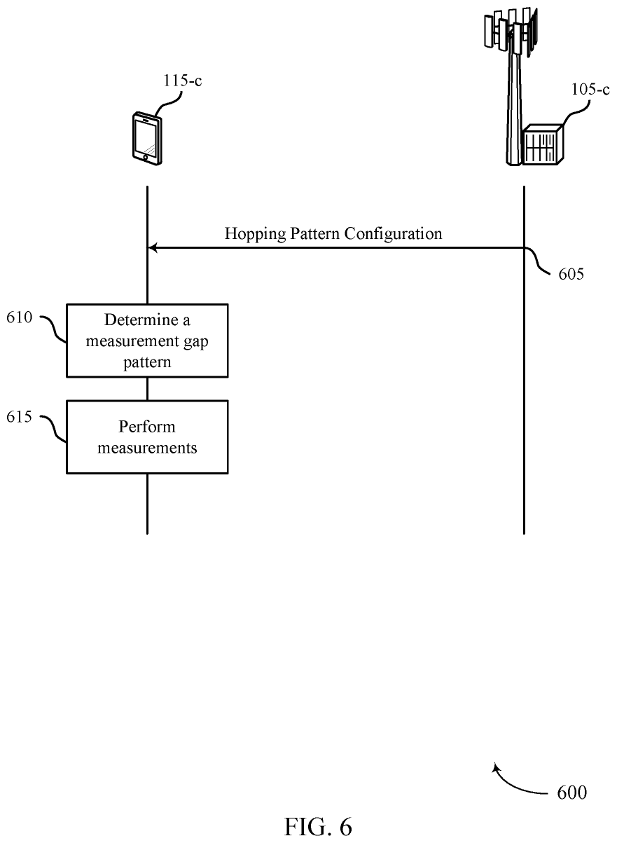

In some other examples, a measurement gap identifier may indicate that a measurement gap pattern excludes measurement gaps. That is, a measurement gap identifier (e.g., MGPattern_id) corresponding to a measurement gap pattern (e.g., one or more measurement gap patterns 415) may be associated with the lack of a measurement gap pattern or may indicate that a measurement gap may not be applicable (e.g., may indicate no measurement gap). Stated alternatively, a single measurement gap identifier may be configured as no-gap. In some cases, a UE 115 may be configured to refrain from using a measurement gap (e.g., may be configured with no-gap) if an association between a measurement gap pattern and a NBWP or an association between a measurement gap pattern and a hopping pattern is not defined. In some other cases, one or more association (e.g., one or more associations 420) may be configured as no-gap (e.g., may correspond to no measurement gap pattern). Accordingly, the UE 115 may refrain from using a measurement gap pattern for such associations. Example techniques for indicating measurement gaps and associating measurement gap patterns with BWP hopping patterns are described in further detail elsewhere herein, including with reference to FIGS. 5 and 6.

FIG. 5 illustrates an example of a process flow 500 in a system that supports techniques for indicating measurement gaps and associating measurement gap patterns with BWP hopping patterns in accordance with aspects of the present disclosure. The process flow 500 may implement or be implemented by one or more aspects of the wireless communications system 100 and the wireless communications system 200. For example, the process flow 500 may include a UE 115-b and a base station 105-b, which may be examples of the corresponding devices as described with reference to FIGS. 1 and 2. The process flow 500 may be implemented by the UE 115-b, the base station 105-b, or both. In the following description of the process flow 500, operations between the UE 115-b and the base station 105-b may occur in a different order or at different times than as shown. Some operations may also be omitted from the process flow 500, and other operations may be added to the process flow 500.

In some examples, the UE 115-b, the base station 105-b, or both, may be configured to support techniques for indicating measurement gaps and associating measurement gap patterns with BWP hopping patterns. For example, at 505, the UE 115-b a may receive signaling, from the base station 105-b, configuring one or more hopping patterns for multiple BWPs. In some cases, each BWP may include RBs having a bandwidth that is less than a threshold bandwidth support by the UE 115-b (e.g., may be a NBWP).

At 510, the UE 115-b may identify hopping pattern identifiers (e.g., one or more of HoppingPattern_id) for each hopping pattern of the one or more hopping patterns. Then, the UE 115-b may optionally generate a hopping pattern identifier list (e.g., for the NBWPHoppingPatternIDList field of an IE). The hopping pattern identifier list may include hopping pattern identifiers for each hopping pattern.

Additionally or alternatively, at 515, the UE 115-b may identify one or more hop region identifiers that correspond to respective frequency-domain regions that include hops associated with the one or more hopping patterns. In some examples, each frequency-domain region includes indices associated with one or more frequency hops. Then, the UE 115-b may optionally generate a hop region list (e.g., for the NBWPHopRegionList field of an IE).

At 520, the UE 115-b may transmit, and the base station 105-b may receive, control signaling indicating measurement gap information for a set of frequency spectrum bands. In some examples, the control signaling may indicate whether a measurement gap is applicable for performing one or more signal measurements. In such examples, the indication may be based on the one or more hopping patterns and a frequency-domain location of the one or more signals to be measured. In some cases, the measurement gap information may include an indication of the hopping pattern identifier list (e.g., may include the NB WPHoppingPatternIDList). In other examples, the measurement gap information may include an indication of the hop region list (e.g., may include the NBWPHopRegionList).

FIG. 6 illustrates an example of a process flow 600 in a system that supports techniques for indicating measurement gaps and associating measurement gap patterns with BWP hopping patterns in accordance with aspects of the present disclosure. The process flow 600 may implement or be implemented by one or more aspects of the wireless communications system 100 and the wireless communications system 200. For example, the process flow 600 may include a UE 115-c and a base station 105-c, which may be examples of the corresponding devices as described with reference to FIGS. 1 and 2. The process flow 600 may be implemented by the UE 115-c, the base station 105-c, or both. In the following description of the process flow 600, operations between the UE 115-c and the base station 105-c, may occur in a different order or at different times than as shown. Some operations may also be omitted from the process flow 600, and other operations may be added to the process flow 600.

In some examples, the UE 115-c, the base station 105-c, or both, may be configured to support techniques for indicating measurement gaps and associating measurement gap patterns with BWP hopping patterns. For example, at 605, the UE 115-c may receive signaling (e.g., from the base station 105-c) configuring one or more hopping patterns for multiple BWPs. In some cases, each BWP may include RBs having a bandwidth that is less than a threshold bandwidth support by the UE 115-c (e.g., each BWP may be a NBWP). Then, at 610, the UE 115-c may determine a measurement gap pattern for an active BWP based on an association between the measurement gap pattern and the active BWP (e.g., active NBWP), or between the measurement gap pattern and a hopping pattern.

At 615, the UE 115-c may perform measurements on one or more signals based on the measurement gap pattern. As an example, the UE 115-c may determine an association between a first BWP and a first measurement gap pattern, and the UE 115-c may perform the measurements using the first measurement gap pattern. In other examples, an active BWP that the UE 115-c is configured with may be modified (e.g., based on signaling (e.g., DCI) from the base station 105-c) to a second, different BWP. In such cases, the UE 115-c may determine an association between the second BWP and a second measurement gap pattern that is different from the first measurement gap pattern. As a result, the UE 115-c may perform the measurements on the one or more signals using the second measurement gap pattern (e.g., after the BWP has changed). In other examples, a hopping pattern for an active BWP may be disabled (e.g., via the signaling received by the UE 115-c at 605 or via other signaling received from the base station 105-c), and the UE 115-c may use a default (e.g., predetermined, preconfigured) measurement gap pattern for the measurements. Here, the default measurement gap pattern may be different for each active BWP, or the default measurement gap pattern may be associated with a hopping pattern that is used to disable the hopping. In some aspects, the association between a BWP and a measurement gap pattern may additionally or alternatively be based on a hopping pattern associated with the active BWP.

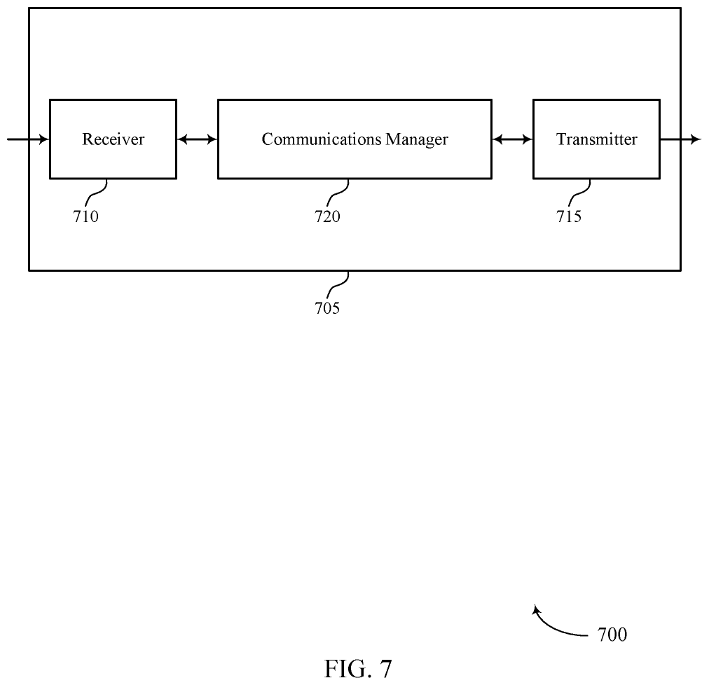

FIG. 7 shows a block diagram 700 of a device 705 that supports techniques for indicating measurement gaps and associating measurement gap patterns with BWP hopping patterns in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for indicating measurement gaps and associating measurement gap patterns with BWP hopping patterns). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for indicating measurement gaps and associating measurement gap patterns with BWP hopping patterns). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for indicating measurement gaps and associating measurement gap patterns with BWP hopping patterns as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. For example, the communications manager 720 may be configured as or otherwise support a means for receiving signaling configuring one or more hopping patterns for a set of multiple BWPs, where each BWP of the set of multiple BWPs includes RBs having a bandwidth less than a threshold bandwidth support by the UE 115 (e.g., may be a NBWP). The communications manager 720 may be configured as or otherwise support a means for transmitting, to a base station (e.g., a base station 105), control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Additionally or alternatively, the communications manager 720 may support wireless communication at the UE 115 in accordance with examples as disclosed herein. For example, the communications manager 720 may be configured as or otherwise support a means for receiving signaling that configures one or more hopping patterns for each BWP of a set of multiple BWPs, where each BWP of the set of multiple BWPs includes RBs having a threshold bandwidth less than a bandwidth support by the UE 115 (e.g., may be a NBWP). The communications manager 720 may be configured as or otherwise support a means for determining a measurement gap pattern for an active BWP based on an association between the measurement gap pattern and the active BWP, or an association between the measurement gap pattern and a hopping pattern from the one or more hopping patterns for the active BWP, or any combination thereof. The communications manager 720 may be configured as or otherwise support a means for performing measurements on one or more signals based on the determined measurement gap pattern.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced processing, reduced power consumption, and more efficient utilization of communication resources.

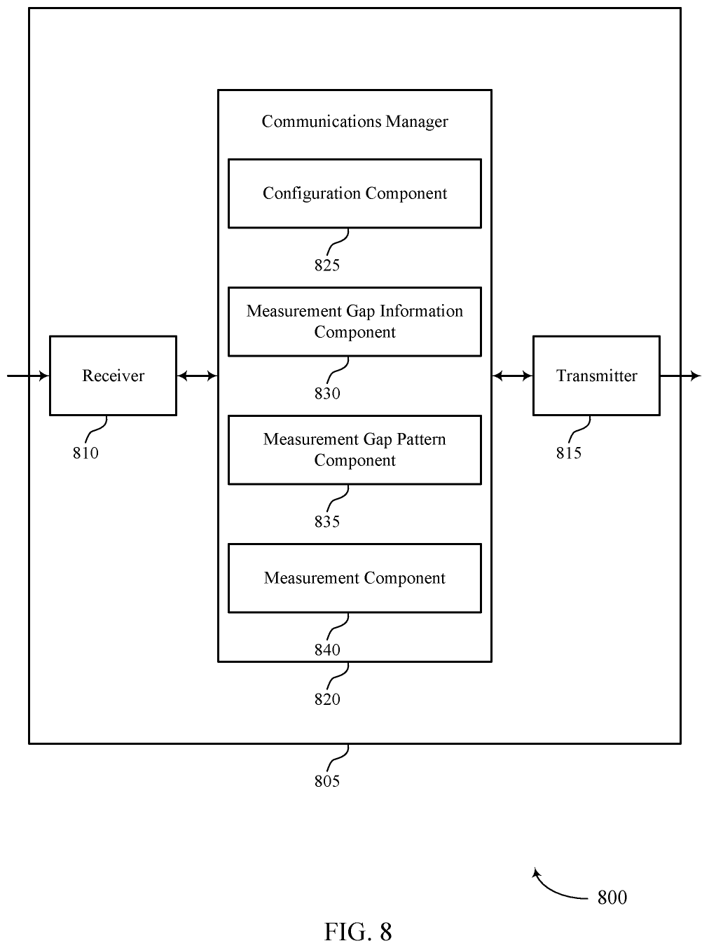

FIG. 8 shows a block diagram 800 of a device 805 that supports techniques for indicating measurement gaps and associating measurement gap patterns with BWP hopping patterns in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for indicating measurement gaps and associating measurement gap patterns with BWP hopping patterns). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for indicating measurement gaps and associating measurement gap patterns with BWP hopping patterns). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for indicating measurement gaps and associating measurement gap patterns with BWP hopping patterns as described herein. For example, the communications manager 820 may include a configuration component 825, a measurement gap information component 830, a measurement gap pattern component 835, a measurement component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at the UE 115 in accordance with examples as disclosed herein. The configuration component 825 may be configured as or otherwise support a means for receiving signaling configuring one or more hopping patterns for a set of multiple BWPs, where each BWP of the set of multiple BWPs includes RBs having a bandwidth less than a threshold bandwidth support by the UE 115 (e.g., may be a NBWP). The measurement gap information component 830 may be configured as or otherwise support a means for transmitting, to a base station (e.g., a base station 105), control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Additionally or alternatively, the communications manager 820 may support wireless communication at the UE 115 in accordance with examples as disclosed herein. The configuration component 825 may be configured as or otherwise support a means for receiving signaling that configures one or more hopping patterns for each BWP of a set of multiple BWPs, where each BWP of the set of multiple BWPs includes RBs having a threshold bandwidth less than a bandwidth support by the UE 115 (e.g., may be a NBWP). The measurement gap pattern component 835 may be configured as or otherwise support a means for determining a measurement gap pattern for an active BWP based on an association between the measurement gap pattern and the active BWP, or an association between the measurement gap pattern and a hopping pattern from the one or more hopping patterns for the active BWP, or any combination thereof. The measurement component 840 may be configured as or otherwise support a means for performing measurements on one or more signals based on the determined measurement gap pattern.

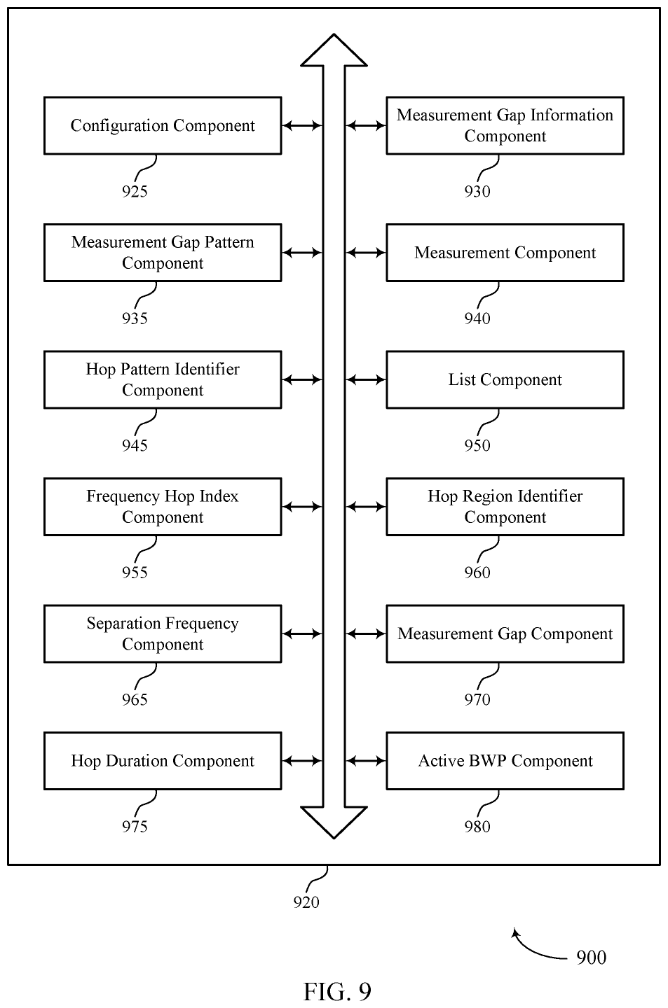

FIG. 9 shows a block diagram 900 of a communications manager 920 that supports techniques for indicating measurement gaps and associating measurement gap patterns with BWP hopping patterns in accordance with aspects of the present disclosure. The communications manager 920 may be an example of aspects of a communications manager 720, a communications manager 820, or both, as described herein. The communications manager 920, or various components thereof, may be an example of means for performing various aspects of techniques for indicating measurement gaps and associating measurement gap patterns with BWP hopping patterns as described herein. For example, the communications manager 920 may include a configuration component 925, a measurement gap information component 930, a measurement gap pattern component 935, a measurement component 940, a hop pattern identifier component 945, a list component 950, a frequency hop index component 955, a hop region identifier component 960, a separation frequency component 965, a measurement gap component 970, a hop duration component 975, an active BWP component 980, or any combination thereof. Each of these components may communicate, directly or indirectly, with one another (e.g., via one or more buses).

The communications manager 920 may support wireless communication at a UE 115 in accordance with examples as disclosed herein. The configuration component 925 may be configured as or otherwise support a means for receiving signaling configuring one or more hopping patterns for a set of multiple BWPs, where each BWP of the set of multiple BWPs includes RBs having a bandwidth less than a threshold bandwidth support by the UE (e.g., may be a NBWP). The measurement gap information component 930 may be configured as or otherwise support a means for transmitting, to a base station (e.g., a base station 105), control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

In some examples, the hop pattern identifier component 945 may be configured as or otherwise support a means for identifying hopping pattern identifiers for each hopping pattern of the one or more hopping patterns. In some examples, the list component 950 may be configured as or otherwise support a means for generating a hopping pattern identifier list including the hopping pattern identifiers for each hopping pattern, where the measurement gap information includes an indication of the hopping pattern identifier list.

In some examples, the frequency hop index component 955 may be configured as or otherwise support a means for identifying indices for one or more frequency hops associated with the one or more hopping patterns. In some examples, the list component 950 may be configured as or otherwise support a means for generating a hop index list including the indices for the one or more frequency hops, where the measurement gap information includes an indication of the hop index list.

In some examples, the hop region identifier component 960 may be configured as or otherwise support a means for identifying one or more hop region identifiers corresponding to respective frequency-domain regions that include hops associated with the one or more hopping patterns, each frequency-domain region of the respective frequency-domain regions including indices for one or more frequency hops. In some examples, the list component 950 may be configured as or otherwise support a means for generating a hop region list including the one or more hop region identifiers, where the measurement gap information includes an indication of the hop region list.

In some examples, the separation frequency component 965 may be configured as or otherwise support a means for identifying a separation frequency between respective hops of the one or more hopping patterns, where the measurement gap information includes an indication of the separation frequency between respective hops. In some examples, the measurement gap component 970 may be configured as or otherwise support a means for determining, for the set of one or more radio frequency spectrum bands, whether the measurement gap is applicable for performing the one or more measurements, where the measurement gap information is based on the determination. In some examples, the measurement gap component 970 may be configured as or otherwise support a means for determining that the measurement gap is not applicable for the set of one or more radio frequency spectrum bands, where the measurement gap information includes an indication that the measurement gap is not applicable based on the determination that the measurement gap is not applicable.

In some examples, the configuration component 925 may be configured as or otherwise support a means for receiving the signal from the base station 105. In some examples, the measurement component 940 may be configured as or otherwise support a means for performing the one or more measurements of the signal based on the measurement gap information. In some examples, the control signaling includes one or more information elements including the measurement gap information.

In some examples, the one or more measurements include intra-frequency measurements of a synchronization signal block. In some examples, the measurement gap information includes intra-frequency measurement gap information. In some examples, the one or more measurements include inter-frequency measurements of a synchronization signal block. In some examples, the measurement gap information includes inter-frequency measurement gap information. In some examples, the one or more measurements include RSRP measurements, RSRQ measurements, SINR measurements, or any combination thereof.

Additionally or alternatively, the communications manager 920 may support wireless communication at the UE 115 in accordance with examples as disclosed herein. In some examples, the configuration component 925 may be configured as or otherwise support a means for receiving signaling that configures one or more hopping patterns for each BWP of a set of multiple BWPs, where each BWP of the set of multiple BWPs includes RBs having a threshold bandwidth less than a bandwidth support by the UE 115 (e.g., may be a NBWP). The measurement gap pattern component 935 may be configured as or otherwise support a means for determining a measurement gap pattern for an active BWP based on an association between the measurement gap pattern and the active BWP, or an association between the measurement gap pattern and a hopping pattern from the one or more hopping patterns for the active BWP, or any combination thereof. The measurement component 940 may be configured as or otherwise support a means for performing measurements on one or more signals based on the determined measurement gap pattern.

In some examples, the hop duration component 975 may be configured as or otherwise support a means for identifying a hop duration associated with each of the one or more hopping patterns, where determining the measurement gap pattern is based on an association between the measurement gap pattern, or the active BWP, or the hopping pattern for the active BWP, or the hop duration, or any combination thereof.

In some examples, to support determining the measurement gap pattern, the measurement gap pattern component 935 may be configured as or otherwise support a means for determining a first measurement gap pattern based on the active BWP, the hopping pattern for the active BWP, or any combination thereof. In some examples, to support determining the measurement gap pattern, the active BWP component 980 may be configured as or otherwise support a means for receiving an indication that the active BWP is being modified from a first BWP to a second BWP different from the first BWP. In some examples, to support determining the measurement gap pattern, the measurement gap pattern component 935 may be configured as or otherwise support a means for determining a second measurement gap pattern based on the second BWP, a second hopping pattern from the one or more hopping patterns for the second BWP, or any combination thereof.

In some examples, to support determining the measurement gap pattern, the measurement gap pattern component 935 may be configured as or otherwise support a means for determining a first measurement gap pattern based on the active BWP, the hopping pattern for the active BWP, or any combination thereof. In some examples, to support determining the measurement gap pattern, the active BWP component 980 may be configured as or otherwise support a means for receiving an indication that the hopping pattern for the active BWP is being modified from a first hopping pattern to a second hopping pattern different from the first hopping pattern. In some examples, to support determining the measurement gap pattern, the measurement gap pattern component 935 may be configured as or otherwise support a means for determining a second measurement gap pattern based on the second hopping pattern.

In some examples, to support determining the measurement gap pattern, the active BWP component 980 may be configured as or otherwise support a means for receiving signaling disabling the hopping pattern for the active BWP. In some examples, to support determining the measurement gap pattern, the measurement gap pattern component 935 may be configured as or otherwise support a means for determining a default measurement gap pattern based on the hopping pattern being disabled. In some examples, the default measurement gap pattern is associated with the active BWP.

In some examples, the active BWP component 980 may be configured as or otherwise support a means for receiving an indication that the hopping pattern for the active BWP is being modified from a first hopping pattern to a second hopping pattern different from the first hopping pattern, the second hopping pattern associated with disabled BWP hopping, where the default measurement gap pattern is associated with the second hopping pattern. In some examples, the measurement gap pattern component 935 may be configured as or otherwise support a means for identifying a measurement gap pattern identifier associated with the determined measurement gap pattern, where the measurement gap pattern identifier corresponds to a predetermined measurement gap pattern that excludes measurement gaps.

In some examples, to support determining the measurement gap pattern, the measurement gap pattern component 935 may be configured as or otherwise support a means for determining the measurement gap pattern based on an absence of the association between the measurement gap pattern and the active BWP, or the association between the measurement gap pattern and a hopping pattern from the one or more hopping patterns for the active BWP, or any combination thereof, where the determined measurement gap pattern excludes measurement gaps.

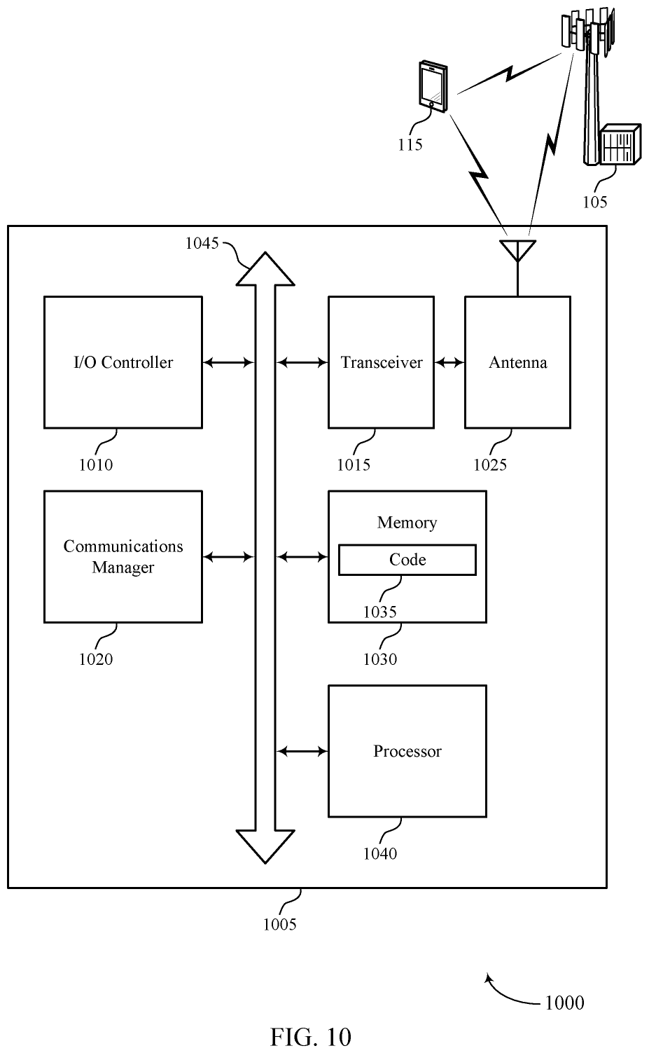

FIG. 10 shows a diagram of a system 1000 including a device 1005 that supports techniques for indicating measurement gaps and associating measurement gap patterns with BWP hopping patterns in accordance with aspects of the present disclosure. The device 1005 may be an example of or include the components of a device 705, a device 805, or a UE 115 as described herein. The device 1005 may communicate wirelessly with one or more base stations 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for indicating measurement gaps and associating measurement gap patterns with BWP hopping patterns). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a UE 115 in accordance with examples as disclosed herein. For example, the communications manager 1020 may be configured as or otherwise support a means for receiving signaling configuring one or more hopping patterns for a set of multiple BWPs, where each BWP of the set of multiple BWPs includes RBs having a bandwidth less than a threshold bandwidth support by the UE 115 (e.g., may be a NBWP). The communications manager 1020 may be configured as or otherwise support a means for transmitting, to a base station 105, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Additionally or alternatively, the communications manager 1020 may support wireless communication at a UE in accordance with examples as disclosed herein. For example, the communications manager 1020 may be configured as or otherwise support a means for receiving signaling that configures one or more hopping patterns for each BWP of a set of multiple BWPs, where each BWP of the set of multiple BWPs includes RBs having a threshold bandwidth less than a bandwidth support by the UE 115 (e.g., may be a NBWP). The communications manager 1020 may be configured as or otherwise support a means for determining a measurement gap pattern for an active BWP based on an association between the measurement gap pattern and the active BWP, or an association between the measurement gap pattern and a hopping pattern from the one or more hopping patterns for the active BWP, or any combination thereof. The communications manager 1020 may be configured as or otherwise support a means for performing measurements on one or more signals based on the determined measurement gap pattern. By including or configuring the communications manager 1020 in accordance with examples as described herein, the device 1005 may support techniques for reduced latency, reduced power consumption, more efficient utilization of communication resources, and longer battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for indicating measurement gaps and associating measurement gap patterns with BWP hopping patterns as described herein, or the processor 1040 and the memory 1030 may be otherwise configured to perform or support such operations.

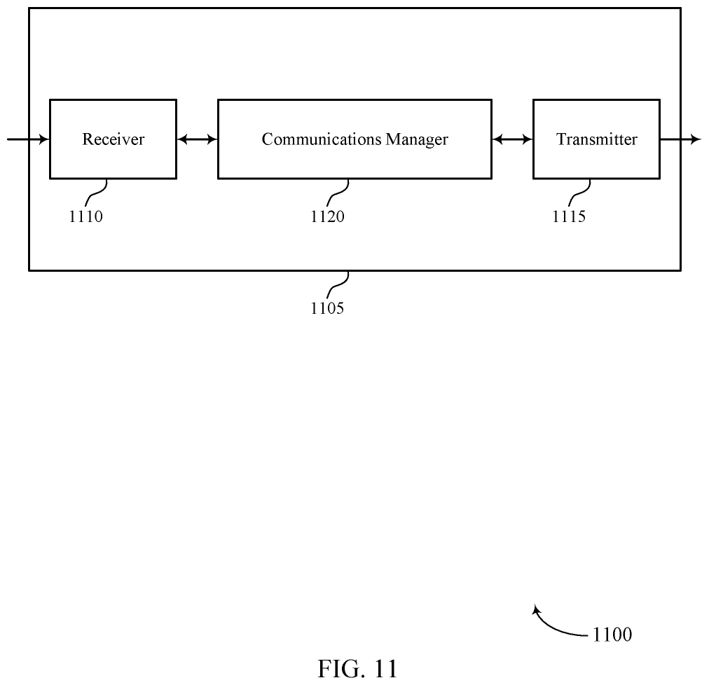

FIG. 11 shows a block diagram 1100 of a device 1105 that supports techniques for indicating measurement gaps and associating measurement gap patterns with BWP hopping patterns in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for indicating measurement gaps and associating measurement gap patterns with BWP hopping patterns). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for indicating measurement gaps and associating measurement gap patterns with BWP hopping patterns). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of techniques for indicating measurement gaps and associating measurement gap patterns with BWP hopping patterns as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

For example, the communications manager 1120 may be configured as or otherwise support a means for transmitting signaling configuring one or more hopping patterns for a set of multiple BWPs, where each BWP of the set of multiple BWPs includes RBs having a bandwidth less than a threshold bandwidth support by a UE (e.g., a UE 115). The communications manager 1120 may be configured as or otherwise support a means for receiving, from the UE, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Additionally or alternatively, the communications manager 1120 may support wireless communications at the base station 105 in accordance with examples as disclosed herein. For example, the communications manager 1120 may be configured as or otherwise support a means for transmitting signaling that configures one or more hopping patterns for each BWP of a set of multiple BWPs, where each BWP of the set of multiple BWPs includes RBs having a threshold bandwidth less than a bandwidth support by the UE 115. The communications manager 1120 may be configured as or otherwise support a means for transmitting, to the UE 115, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced power consumption and more efficient utilization of communication resources.

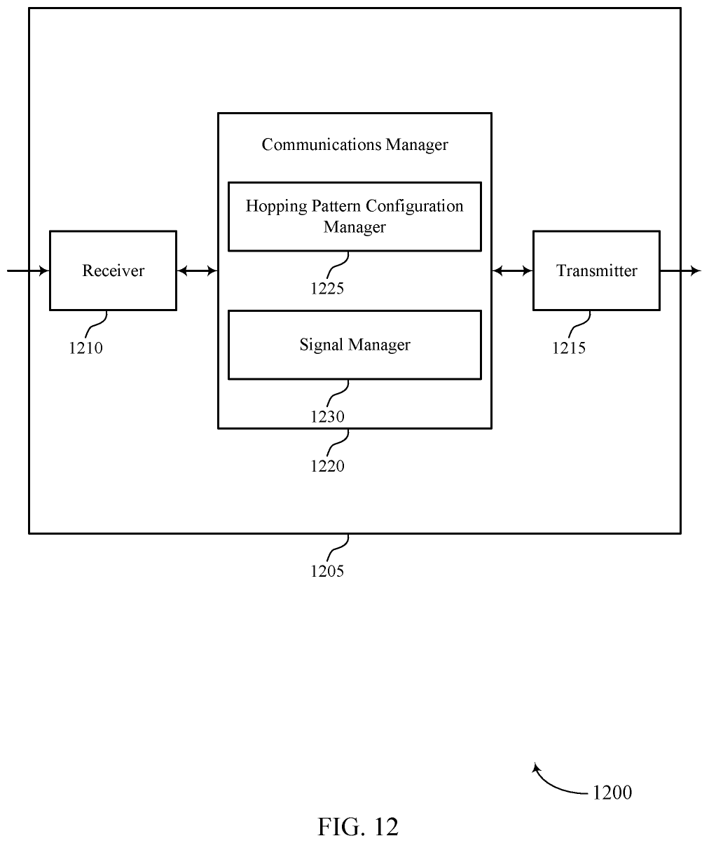

FIG. 12 shows a block diagram 1200 of a device 1205 that supports techniques for indicating measurement gaps and associating measurement gap patterns with BWP hopping patterns in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for indicating measurement gaps and associating measurement gap patterns with BWP hopping patterns). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for indicating measurement gaps and associating measurement gap patterns with BWP hopping patterns). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for indicating measurement gaps and associating measurement gap patterns with BWP hopping patterns as described herein. For example, the communications manager 1220 may include a hopping pattern configuration manager 1225 a signal manager 1230, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The hopping pattern configuration manager 1225 may be configured as or otherwise support a means for transmitting signaling configuring one or more hopping patterns for a set of multiple BWPs, where each BWP of the set of multiple BWPs includes RBs having a bandwidth less than a threshold bandwidth support by a UE (e.g., a UE 115). The signal manager 1230 may be configured as or otherwise support a means for receiving, from the UE 115, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Additionally or alternatively, the communications manager 1220 may support wireless communications at the base station 105 in accordance with examples as disclosed herein. The hopping pattern configuration manager 1225 may be configured as or otherwise support a means for transmitting signaling that configures one or more hopping patterns for each BWP of a set of multiple BWPs, where each BWP of the set of multiple BWPs includes RBs having a threshold bandwidth less than a bandwidth support by the UE 115. The signal manager 1230 may be configured as or otherwise support a means for transmitting, to the UE 115, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof.

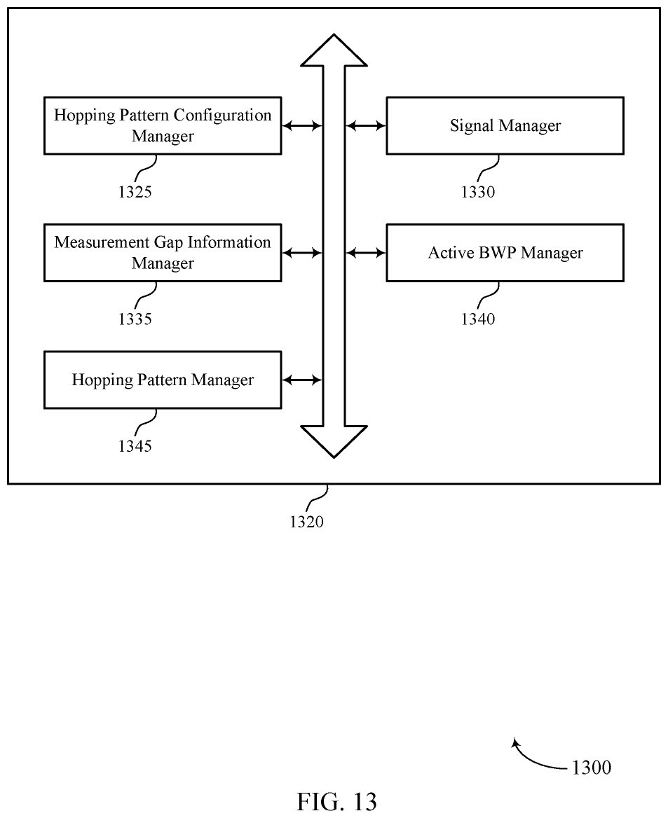

FIG. 13 shows a block diagram 1300 of a communications manager 1320 that supports techniques for indicating measurement gaps and associating measurement gap patterns with BWP hopping patterns in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of techniques for indicating measurement gaps and associating measurement gap patterns with BWP hopping patterns as described herein. For example, the communications manager 1320 may include a hopping pattern configuration manager 1325, a signal manager 1330, a measurement gap information manager 1335, an active BWP manager 1340, a hopping pattern manager 1345, or any combination thereof. Each of these components may communicate, directly or indirectly, with one another (e.g., via one or more buses).

The hopping pattern configuration manager 1325 may be configured as or otherwise support a means for transmitting signaling configuring one or more hopping patterns for a set of multiple BWPs, where each BWP of the set of multiple BWPs includes RBs having a bandwidth less than a threshold bandwidth support by a UE (e.g., a UE 115). The signal manager 1330 may be configured as or otherwise support a means for receiving, from the UE 115, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

In some examples, to support receiving the control signaling indicating the measurement gap information, the measurement gap information manager 1335 may be configured as or otherwise support a means for receiving, as part of the measurement gap information, an indication of a hopping pattern identifier list including hopping pattern identifiers for each hopping pattern of the one or more hopping patterns. In some examples, to support receiving the control signaling indicating the measurement gap information, the measurement gap information manager 1335 may be configured as or otherwise support a means for receiving, as part of the measurement gap information, an indication of a hop index list including indices for one or more frequency hops associated with the one or more hopping patterns.

In some examples, to support receiving the control signaling indicating the measurement gap information, the measurement gap information manager 1335 may be configured as or otherwise support a means for receiving, as part of the measurement gap information, an indication of a hop region list including one or more hop region identifiers corresponding to respective frequency-domain regions that include hops associated with the one or more hopping patterns, each frequency-domain region of the respective frequency-domain regions including indices for one or more frequency hops.

Additionally or alternatively, the communications manager 1320 may support wireless communications at a base station (e.g., a base station 105) in accordance with examples as disclosed herein. In some examples, the hopping pattern configuration manager 1325 may be configured as or otherwise support a means for transmitting signaling that configures one or more hopping patterns for each BWP of a set of multiple BWPs, where each BWP of the set of multiple BWPs includes RBs having a threshold bandwidth less than a bandwidth support by the UE 115. In some examples, the signal manager 1330 may be configured as or otherwise support a means for transmitting, to the UE 115, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof.

In some examples, the active BWP manager 1340 may be configured as or otherwise support a means for transmitting, to the UE 115, an indication that the active BWP is being modified from a first BWP to a second BWP different from the first BWP, where a second measurement gap pattern is based on the second BWP, a second hopping pattern from the one or more hopping patterns for the second BWP, or any combination thereof. In some examples, transmitting signaling disables the hopping pattern for the active BWP. In some examples, to transmit the one or more signals, the active BWP manager 1340 may be configured as or otherwise support a means for transmitting the one or more signals based on a default measurement gap pattern that is associated with the hopping pattern being disabled. In some examples, the default measurement gap pattern is associated with the active BWP.

In some examples, the hopping pattern manager 1345 may be configured as or otherwise support a means for transmitting an indication that the hopping pattern for the active BWP is being modified from a first hopping pattern to a second hopping pattern different from the first hopping pattern, the second hopping pattern associated with disabled BWP hopping, where the default measurement gap pattern is associated with the second hopping pattern.

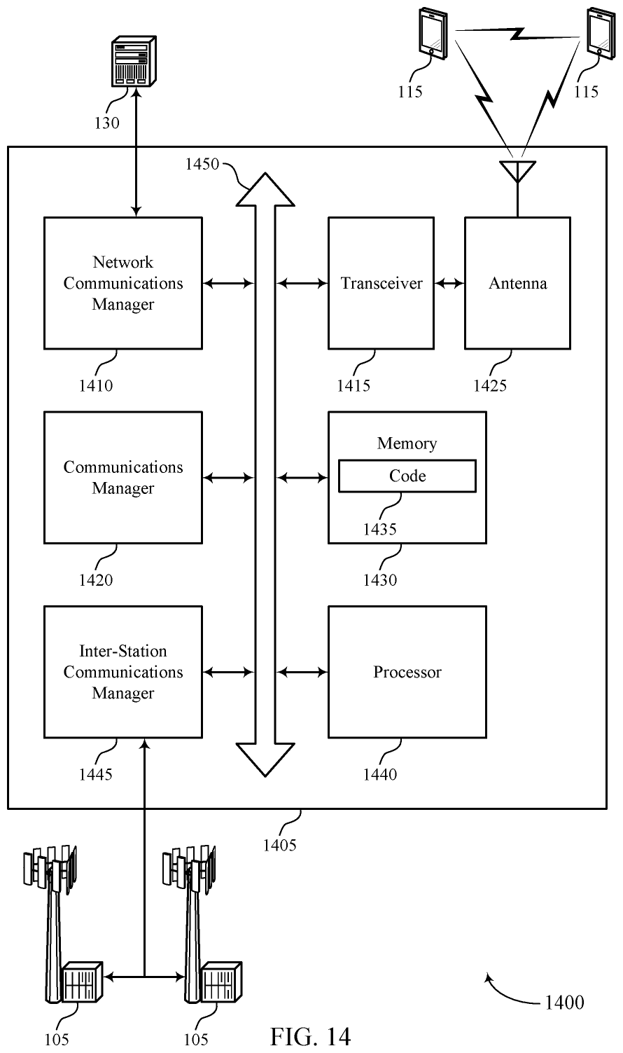

FIG. 14 shows a diagram of a system 1400 including a device 1405 that supports techniques for indicating measurement gaps and associating measurement gap patterns with BWP hopping patterns in accordance with aspects of the present disclosure. The device 1405 may be an example of or include the components of a device 1105, a device 1205, or a base station 105 as described herein. The device 1405 may communicate wirelessly with one or more base stations 105, one or more UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting techniques for indicating measurement gaps and associating measurement gap patterns with BWP hopping patterns). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with one or more UEs 115 in cooperation with other base stations 105. For example, the inter-station communications manager 1445 may coordinate scheduling for transmissions to one or more UEs 115 for various interference mitigation techniques such as beamforming or joint transmission. In some examples, the inter-station communications manager 1445 may provide an X2 interface within an LTE/LTE-A wireless communications network technology to provide communication between base stations 105.

For example, the communications manager 1420 may be configured as or otherwise support a means for transmitting signaling configuring one or more hopping patterns for a set of multiple BWPs, where each BWP of the set of multiple BWPs includes RBs having a bandwidth less than a threshold bandwidth support by a UE. The communications manager 1420 may be configured as or otherwise support a means for receiving, from the UE, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements.

Additionally or alternatively, the communications manager 1420 may support wireless communications at a base station in accordance with examples as disclosed herein. For example, the communications manager 1420 may be configured as or otherwise support a means for transmitting signaling that configures one or more hopping patterns for each BWP of a set of multiple BWPs, where each BWP of the set of multiple BWPs includes RBs having a threshold bandwidth less than a bandwidth support by a UE (e.g., a UE 115). The communications manager 1420 may be configured as or otherwise support a means for transmitting, to the UE 115, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof. By including or configuring the communications manager 1420 in accordance with examples as described herein, the device 1405 may support techniques for reduced latency, reduced power consumption, more efficient utilization of communication resources, and longer battery life.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of techniques for indicating measurement gaps and associating measurement gap patterns with BWP hopping patterns as described herein, or the processor 1440 and the memory 1430 may be otherwise configured to perform or support such operations.

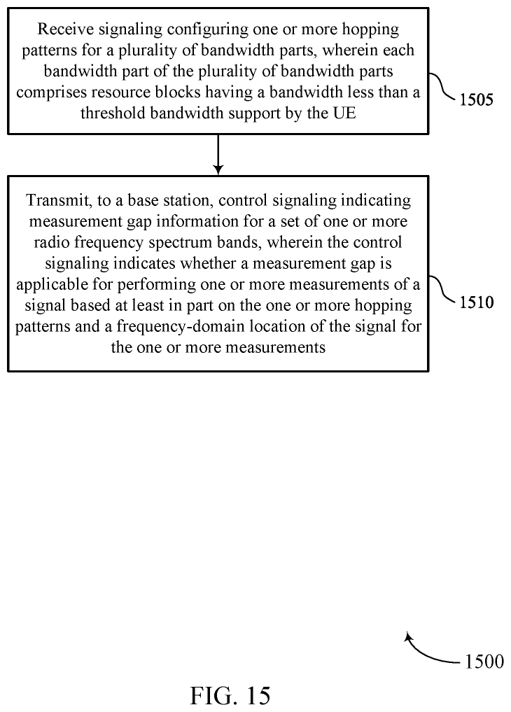

FIG. 15 shows a flowchart illustrating a method 1500 that supports techniques for indicating measurement gaps and associating measurement gap patterns with BWP hopping patterns in accordance with aspects of the present disclosure. The operations of the method 1500 may be implemented by a UE (e.g., a UE 115) or its components as described herein. For example, the operations of the method 1500 may be performed by the UE 115 as described with reference to FIGS. 1 through 10. In some examples, the UE 115 may execute a set of instructions to control the functional elements of the UE 115 to perform the described functions. Additionally or alternatively, the UE 115 may perform aspects of the described functions using special-purpose hardware.

At 1505, the method may include receiving signaling configuring one or more hopping patterns for a set of multiple BWPs, where each BWP of the set of multiple BWPs includes RBs having a bandwidth less than a threshold bandwidth support by the UE 115. The operations of 1505 may be performed in accordance with examples as disclosed herein. In some examples, aspects of the operations of 1505 may be performed by a configuration component 925 as described with reference to FIG. 9.

At 1510, the method may include transmitting, to a base station (e.g., a base station 105), control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements. The operations of 1510 may be performed in accordance with examples as disclosed herein. In some examples, aspects of the operations of 1510 may be performed by a measurement gap information component 930 as described with reference to FIG. 9.

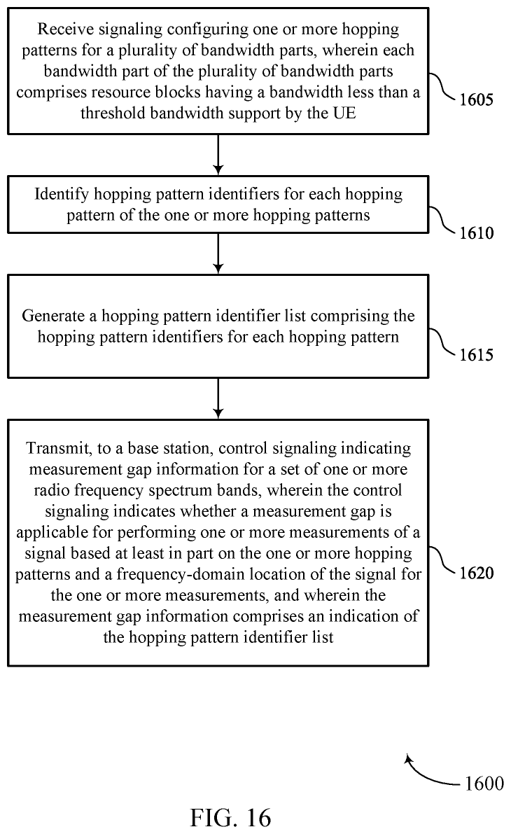

FIG. 16 shows a flowchart illustrating a method 1600 that supports techniques for indicating measurement gaps and associating measurement gap patterns with BWP hopping patterns in accordance with aspects of the present disclosure. The operations of the method 1600 may be implemented by a UE (e.g., a UE 115) or its components as described herein. For example, the operations of the method 1600 may be performed by the UE 115 as described with reference to FIGS. 1 through 10. In some examples, the UE 115 may execute a set of instructions to control the functional elements of the UE to perform the described functions. Additionally or alternatively, the UE 115 may perform aspects of the described functions using special-purpose hardware.

At 1605, the method may include receiving signaling configuring one or more hopping patterns for a set of multiple BWPs, where each BWP of the set of multiple BWPs includes RBs having a bandwidth less than a threshold bandwidth support by the UE 115. The operations of 1605 may be performed in accordance with examples as disclosed herein. In some examples, aspects of the operations of 1605 may be performed by a configuration component 925 as described with reference to FIG. 9.

At 1610, the method may include identifying hopping pattern identifiers for each hopping pattern of the one or more hopping patterns. The operations of 1610 may be performed in accordance with examples as disclosed herein. In some examples, aspects of the operations of 1610 may be performed by a hop pattern identifier component 945 as described with reference to FIG. 9.

At 1615, the method may include generating a hopping pattern identifier list including the hopping pattern identifiers for each hopping pattern. The operations of 1615 may be performed in accordance with examples as disclosed herein. In some examples, aspects of the operations of 1615 may be performed by a list component 950 as described with reference to FIG. 9.

At 1620, the method may include transmitting, to a base station (e.g., a base station 105), control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements. In some examples, the measurement gap information includes an indication of the hopping pattern identifier list. The operations of 1620 may be performed in accordance with examples as disclosed herein. In some examples, aspects of the operations of 1620 may be performed by a measurement gap information component 930 as described with reference to FIG. 9.

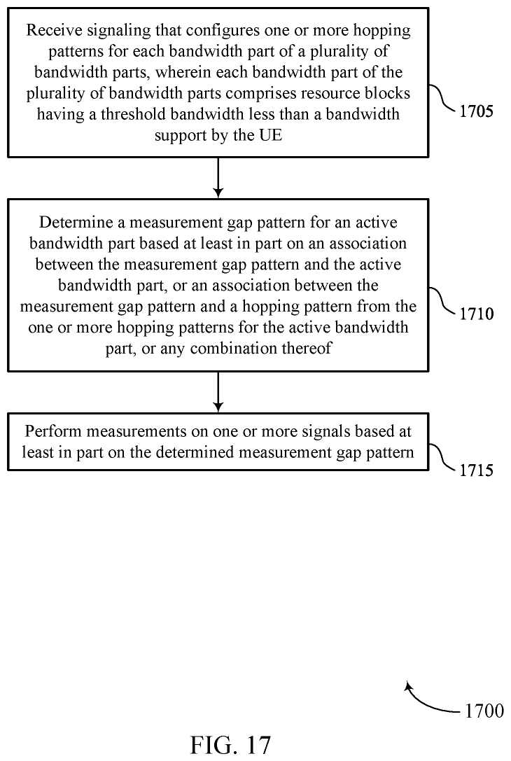

FIG. 17 shows a flowchart illustrating a method 1700 that supports techniques for indicating measurement gaps and associating measurement gap patterns with BWP hopping patterns in accordance with aspects of the present disclosure. The operations of the method 1700 may be implemented by a UE (e.g., a UE 115) or its components as described herein. For example, the operations of the method 1700 may be performed by the UE 115 as described with reference to FIGS. 1 through 10. In some examples, the UE 115 may execute a set of instructions to control the functional elements of the UE 115 to perform the described functions. Additionally or alternatively, the UE 115 may perform aspects of the described functions using special-purpose hardware.

At 1705, the method may include receiving signaling that configures one or more hopping patterns for each BWP of a set of multiple BWPs, where each BWP of the set of multiple BWPs includes RBs having a threshold bandwidth less than a bandwidth support by the UE 115. The operations of 1705 may be performed in accordance with examples as disclosed herein. In some examples, aspects of the operations of 1705 may be performed by a configuration component 925 as described with reference to FIG. 9.

At 1710, the method may include determining a measurement gap pattern for an active BWP based on an association between the measurement gap pattern and the active BWP, or an association between the measurement gap pattern and a hopping pattern from the one or more hopping patterns for the active BWP, or any combination thereof. The operations of 1710 may be performed in accordance with examples as disclosed herein. In some examples, aspects of the operations of 1710 may be performed by a measurement gap pattern component 935 as described with reference to FIG. 9.

At 1715, the method may include performing measurements on one or more signals based on the determined measurement gap pattern. The operations of 1715 may be performed in accordance with examples as disclosed herein. In some examples, aspects of the operations of 1715 may be performed by a measurement component 940 as described with reference to FIG. 9.

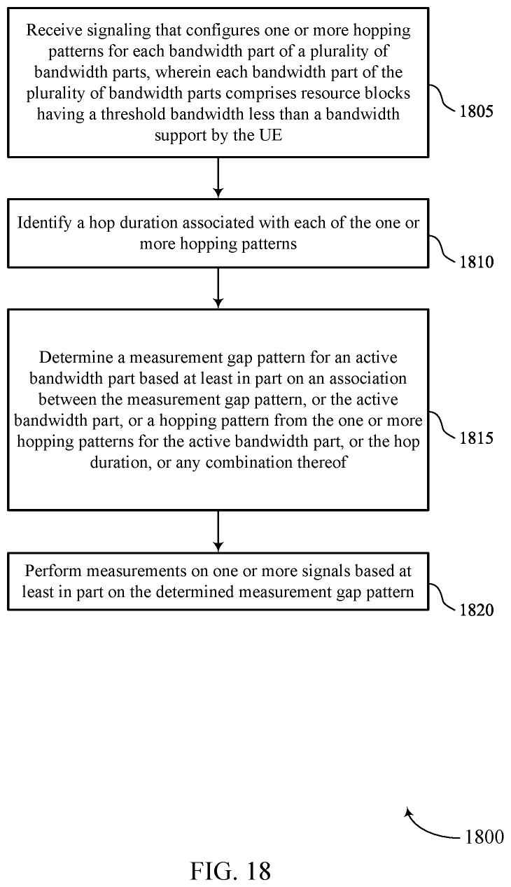

FIG. 18 shows a flowchart illustrating a method 1800 that supports techniques for indicating measurement gaps and associating measurement gap patterns with BWP hopping patterns in accordance with aspects of the present disclosure. The operations of the method 1800 may be implemented by a UE (e.g., a UE 115) or its components as described herein. For example, the operations of the method 1800 may be performed by the UE 115 as described with reference to FIGS. 1 through 10. In some examples, the UE 115 may execute a set of instructions to control the functional elements of the UE 115 to perform the described functions. Additionally or alternatively, the UE 115 may perform aspects of the described functions using special-purpose hardware.

At 1805, the method may include receiving signaling that configures one or more hopping patterns for each BWP of a set of multiple BWPs, where each BWP of the set of multiple BWPs includes RBs having a threshold bandwidth less than a bandwidth support by the UE 115. The operations of 1805 may be performed in accordance with examples as disclosed herein. In some examples, aspects of the operations of 1805 may be performed by a configuration component 925 as described with reference to FIG. 9.

At 1810, the method may include identifying a hop duration associated with each of the one or more hopping patterns. The operations of 1810 may be performed in accordance with examples as disclosed herein. In some examples, aspects of the operations of 1810 may be performed by a hop duration component 975 as described with reference to FIG. 9.

At 1815, the method may include determining a measurement gap pattern for an active BWP based on an association between the measurement gap pattern and the active BWP, or an association between the measurement gap pattern and a hopping pattern from the one or more hopping patterns for the active BWP, or any combination thereof. Additionally or alternatively, determining the measurement gap pattern is based on an association between the measurement gap pattern, or the active BWP, or the hopping pattern for the active BWP, or the hop duration, or any combination thereof. The operations of 1815 may be performed in accordance with examples as disclosed herein. In some examples, aspects of the operations of 1815 may be performed by a measurement gap pattern component 935 as described with reference to FIG. 9.

At 1820, the method may include performing measurements on one or more signals based on the determined measurement gap pattern. The operations of 1820 may be performed in accordance with examples as disclosed herein. In some examples, aspects of the operations of 1820 may be performed by a measurement component 940 as described with reference to FIG. 9.

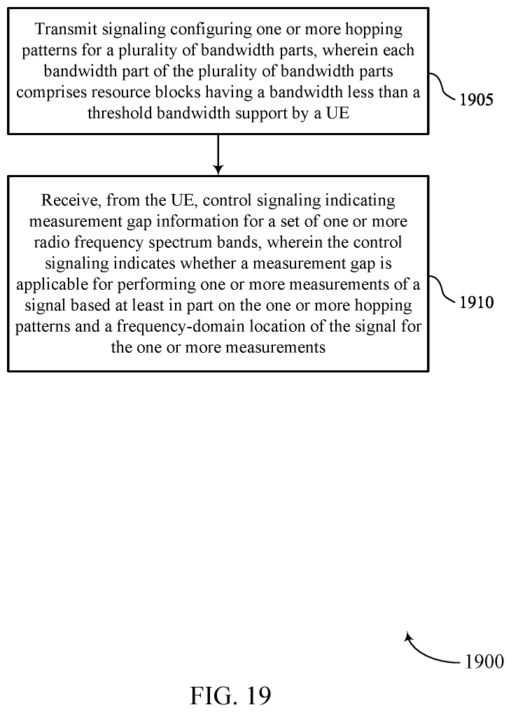

FIG. 19 shows a flowchart illustrating a method 1900 that supports techniques for indicating measurement gaps and associating measurement gap patterns with BWP hopping patterns in accordance with aspects of the present disclosure. The operations of the method 1900 may be implemented by a base station (e.g., a base station 105) or its components as described herein. For example, the operations of the method 1900 may be performed by the base station 105 as described with reference to FIGS. 1 through 6 and 11 through 14. In some examples, a base station may execute a set of instructions to control the functional elements of the base station 105 to perform the described functions. Additionally or alternatively, the base station 105 may perform aspects of the described functions using special-purpose hardware.

At 1905, the method may include transmitting signaling configuring one or more hopping patterns for a set of multiple BWPs, where each BWP of the set of multiple BWPs includes RBs having a bandwidth less than a threshold bandwidth support by a UE (e.g., a UE 115). The operations of 1905 may be performed in accordance with examples as disclosed herein. In some examples, aspects of the operations of 1905 may be performed by a hopping pattern configuration manager 1325 as described with reference to FIG. 13.

At 1910, the method may include receiving, from the UE 115, control signaling indicating measurement gap information for a set of one or more radio frequency spectrum bands, where the control signaling indicates whether a measurement gap is applicable for performing one or more measurements of a signal based on the one or more hopping patterns and a frequency-domain location of the signal for the one or more measurements. The operations of 1910 may be performed in accordance with examples as disclosed herein. In some examples, aspects of the operations of 1910 may be performed by a signal manager 1330 as described with reference to FIG. 13.

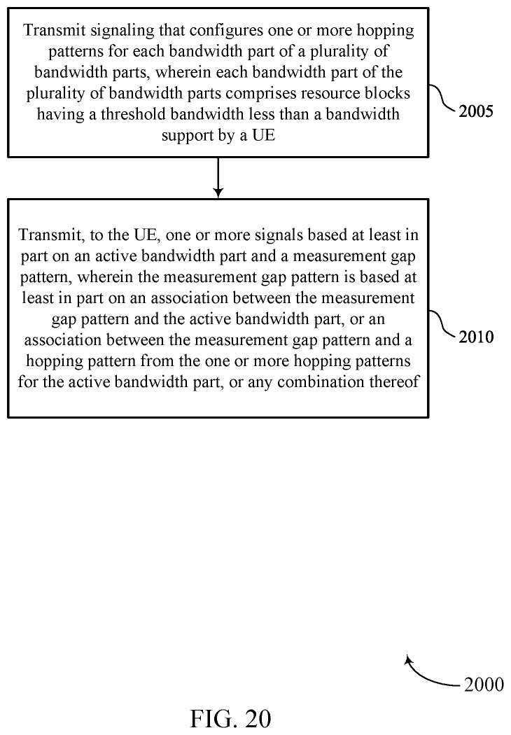

FIG. 20 shows a flowchart illustrating a method 2000 that supports techniques for indicating measurement gaps and associating measurement gap patterns with BWP hopping patterns in accordance with aspects of the present disclosure. The operations of the method 2000 may be implemented by a base station (e.g., a base station 105) or its components as described herein. For example, the operations of the method 2000 may be performed by the base station 105 as described with reference to FIGS. 1 through 6 and 11 through 14. In some examples, the base station 105 may execute a set of instructions to control the functional elements of the base station 105 to perform the described functions. Additionally or alternatively, the base station 105 may perform aspects of the described functions using special-purpose hardware.

At 2005, the method may include transmitting signaling that configures one or more hopping patterns for each BWP of a set of multiple BWPs (e.g., NBWPs), where each BWP of the set of multiple BWPs includes RBs having a threshold bandwidth less than a bandwidth support by a UE (e.g., a UE 115). The operations of 2005 may be performed in accordance with examples as disclosed herein. In some examples, aspects of the operations of 2005 may be performed by a hopping pattern configuration manager 1325 as described with reference to FIG. 13.

At 2010, the method may include transmitting, to the UE 115, one or more signals based on an active BWP and a measurement gap pattern, where the measurement gap pattern is based on an association between the measurement gap pattern and the active BWP, or an association between the measurement gap pattern and a hopping pattern from the one or more hopping patterns for the active BWP, or any combination thereof. The operations of 2010 may be performed in accordance with examples as disclosed herein. In some examples, aspects of the operations of 2010 may be performed by a signal manager 1330 as described with reference to FIG. 13.

The following provides an overview of aspects of the present disclosure:

Aspect 1: A method for wireless communication at a UE, comprising: receiving signaling configuring one or more hopping patterns for a plurality of bandwidth parts, wherein each bandwidth part of the plurality of bandwidth parts comprises resource blocks having a bandwidth less than a threshold bandwidth support by the UE; and transmitting, to a base station, control signaling indicating measurement gap information for a set of one or more radio frequency spectrum bands, wherein the control signaling indicates whether a measurement gap is applicable for performing one or more measurements of a signal based at least in part on the one or more hopping patterns and a frequency-domain location of the signal for the one or more measurements.

Aspect 2: The method of aspect 1, further comprising: identifying hopping pattern identifiers for each hopping pattern of the one or more hopping patterns; and generating a hopping pattern identifier list comprising the hopping pattern identifiers for each hopping pattern, wherein the measurement gap information comprises an indication of the hopping pattern identifier list.

Aspect 3: The method of any of aspects 1 through 2, further comprising: identifying indices for one or more frequency hops associated with the one or more hopping patterns; and generating a hop index list comprising the indices for the one or more frequency hops, wherein the measurement gap information comprises an indication of the hop index list.

Aspect 4: The method of any of aspects 1 through 3, further comprising: identifying one or more hop region identifiers corresponding to respective frequency-domain regions that include hops associated with the one or more hopping patterns, each frequency-domain region of the respective frequency-domain regions comprising indices for one or more frequency hops; and generating a hop region list comprising the one or more hop region identifiers, wherein the measurement gap information comprises an indication of the hop region list.

Aspect 5: The method of any of aspects 1 through 4, further comprising: identifying a separation frequency between respective hops of the one or more hopping patterns, wherein the measurement gap information comprises an indication of the separation frequency between the respective hops.

Aspect 6: The method of any of aspects 1 through 5, further comprising: determining, for the set of one or more radio frequency spectrum bands, whether the measurement gap is applicable for performing the one or more measurements, wherein the measurement gap information is based at least in part on the determination.

Aspect 7: The method of aspect 6, further comprising; determining that the measurement gap is not applicable for the set of one or more radio frequency spectrum bands, wherein the measurement gap information comprises an indication that the measurement gap is not applicable based at least in part on the determination that the measurement gap is not applicable.

Aspect 8: The method of any of aspects 1 through 7, further comprising: receiving the signal from the base station; and performing the one or more measurements of the signal based at least in part on the measurement gap information.

Aspect 9: The method of any of aspects 1 through 8, wherein the control signaling includes one or more information elements comprising the measurement gap information.

Aspect 10: The method of any of aspects 1 through 9, wherein the one or more measurements comprise intra-frequency measurements of a synchronization signal block, and the measurement gap information comprises intra-frequency measurement gap information.

Aspect 11: The method of any of aspects 1 through 9, wherein the one or more measurements comprise inter-frequency measurements of a synchronization signal block, and the measurement gap information comprises inter-frequency measurement gap information.

Aspect 12: The method of any of aspects 1 through 11, wherein the one or more measurements comprise RSRP measurements, RSRQ measurements, SINR measurements, or any combination thereof.

Aspect 13: A method for wireless communication at a UE, comprising: receiving signaling that configures one or more hopping patterns for each bandwidth part of a plurality of bandwidth parts, wherein each bandwidth part of the plurality of bandwidth parts comprises resource blocks having a threshold bandwidth less than a bandwidth support by the UE; determining a measurement gap pattern for an active bandwidth part based at least in part on an association between the measurement gap pattern and the active bandwidth part, or an association between the measurement gap pattern and a hopping pattern from the one or more hopping patterns for the active bandwidth part, or any combination thereof; and performing measurements on one or more signals based at least in part on the determined measurement gap pattern.

Aspect 14: The method of aspect 13, further comprising: identifying a hop duration associated with each of the one or more hopping patterns, wherein determining the measurement gap pattern is based at least in part on the association between the measurement gap pattern, or the active bandwidth part, or the hopping pattern for the active bandwidth part, or the hop duration, or any combination thereof.

Aspect 15: The method of any of aspects 13 through 14, wherein determining the measurement gap pattern comprises: determining a first measurement gap pattern based at least in part on the active bandwidth part, the hopping pattern for the active bandwidth part, or any combination thereof; receiving an indication that the active bandwidth part is being modified from a first bandwidth part to a second bandwidth part different from the first bandwidth part; and determining a second measurement gap pattern based at least in part on the second bandwidth part, a second hopping pattern from the one or more hopping patterns for the second bandwidth part, or any combination thereof.

Aspect 16: The method of any of aspects 13 through 15, wherein determining the measurement gap pattern comprises: determining a first measurement gap pattern based at least in part on the active bandwidth part, the hopping pattern for the active bandwidth part, or any combination thereof; receiving an indication that the hopping pattern for the active bandwidth part is being modified from a first hopping pattern to a second hopping pattern different from the first hopping pattern; and determining a second measurement gap pattern based at least in part on the second hopping pattern.

Aspect 17: The method of any of aspects 13 through 16, wherein determining the measurement gap pattern comprises: receiving signaling disabling the hopping pattern for the active bandwidth part; and determining a default measurement gap pattern based at least in part on the hopping pattern being disabled.

Aspect 18: The method of aspect 17, wherein the default measurement gap pattern is associated with the active bandwidth part.

Aspect 19: The method of any of aspects 17 through 18, further comprising: receiving an indication that the hopping pattern for the active bandwidth part is being modified from a first hopping pattern to a second hopping pattern different from the first hopping pattern, the second hopping pattern being associated with disabled bandwidth part hopping, wherein the default measurement gap pattern is associated with the second hopping pattern.

Aspect 20: The method of any of aspects 13 through 19, further comprising: identifying a measurement gap pattern identifier associated with the determined measurement gap pattern, wherein the measurement gap pattern identifier corresponds to a predetermined measurement gap pattern that excludes measurement gaps.

Aspect 21: The method of any of aspects 13 through 20, wherein determining the measurement gap pattern comprises: determining the measurement gap pattern based at least in part on an absence of the association between the measurement gap pattern and the active bandwidth part, or the association between the measurement gap pattern and the hopping pattern from the one or more hopping patterns for the active bandwidth part, or any combination thereof, wherein the determined measurement gap pattern excludes measurement gaps.

Aspect 22: A method for wireless communication at a base station comprising: transmitting signaling configuring one or more hopping patterns for a plurality of bandwidth parts, wherein each bandwidth part of the plurality of bandwidth parts comprises resource blocks having a bandwidth less than a threshold bandwidth support by a UE; and receiving, from the UE, control signaling indicating measurement gap information for a set of one or more radio frequency spectrum bands, wherein the control signaling indicates whether a measurement gap is applicable for performing one or more measurements of a signal based at least in part on the one or more hopping patterns and a frequency-domain location of the signal for the one or more measurements.

Aspect 23: The method of aspect 22, wherein receiving the control signaling indicating the measurement gap information comprises: receiving, as part of the measurement gap information, an indication of a hopping pattern identifier list comprising hopping pattern identifiers for each hopping pattern of the one or more hopping patterns.

Aspect 24: The method of any of aspects 22 through 23, wherein receiving the control signaling indicating the measurement gap information comprises: receiving, as part of the measurement gap information, an indication of a hop index list comprising indices for one or more frequency hops associated with the one or more hopping patterns.

Aspect 25: The method of any of aspects 22 through 24, wherein receiving the control signaling indicating the measurement gap information comprises: receiving, as part of the measurement gap information, an indication of a hop region list comprising one or more hop region identifiers corresponding to respective frequency-domain regions that include hops associated with the one or more hopping patterns, each frequency-domain region of the respective frequency-domain regions comprising indices for one or more frequency hops.

Aspect 26: A method for wireless communications at a base station, comprising: transmitting signaling that configures one or more hopping patterns for each bandwidth part of a plurality of bandwidth parts, wherein each bandwidth part of the plurality of bandwidth parts comprises resource blocks having a threshold bandwidth less than a bandwidth support by a UE; and transmitting, to the UE, one or more signals based at least in part on an active bandwidth part and a measurement gap pattern, wherein the measurement gap pattern is based at least in part on an association between the measurement gap pattern and the active bandwidth part, or an association between the measurement gap pattern and a hopping pattern from the one or more hopping patterns for the active bandwidth part, or any combination thereof.

Aspect 27: The method of aspect 26, further comprising: transmitting, to the UE, an indication that the active bandwidth part is being modified from a first bandwidth part to a second bandwidth part different from the first bandwidth part, wherein a second measurement gap pattern is based at least in part on the second bandwidth part, a second hopping pattern from the one or more hopping patterns for the second bandwidth part, or any combination thereof.

Aspect 28: The method of any of aspects 26 through 27, wherein transmitting signaling disabling the hopping pattern for the active bandwidth part, wherein transmitting the one or more signals comprises: transmitting the one or more signals based at least in part on a default measurement gap pattern that is associated with the hopping pattern being disabled.

Aspect 29: The method of aspect 28, wherein the default measurement gap pattern is associated with the active bandwidth part.

Aspect 30: The method of any of aspects 28 through 29, further comprising: transmitting an indication that the hopping pattern for the active bandwidth part is being modified from a first hopping pattern to a second hopping pattern different from the first hopping pattern, the second hopping pattern associated with disabled bandwidth part hopping, wherein the default measurement gap pattern is associated with the second hopping pattern.

Aspect 31: An apparatus for wireless communication at a UE, comprising a processor; memory coupled with the processor; and instructions stored in the memory and executable by the processor to cause the apparatus to perform a method of any of aspects 1 through 12.

Aspect 32: An apparatus for wireless communication at a UE, comprising at least one means for performing a method of any of aspects 1 through 12.

Aspect 33: A non-transitory computer-readable medium storing code for wireless communication at a UE, the code comprising instructions executable by a processor to perform a method of any of aspects 1 through 12.

Aspect 34: An apparatus for wireless communication at a UE, comprising a processor; memory coupled with the processor; and instructions stored in the memory and executable by the processor to cause the apparatus to perform a method of any of aspects 13 through 21.

Aspect 35: An apparatus for wireless communication at a UE, comprising at least one means for performing a method of any of aspects 13 through 21.

Aspect 36: A non-transitory computer-readable medium storing code for wireless communication at a UE, the code comprising instructions executable by a processor to perform a method of any of aspects 13 through 21.

Aspect 37: An apparatus comprising a processor; memory coupled with the processor; and instructions stored in the memory and executable by the processor to cause the apparatus to perform a method of any of aspects 22 through 25.

Aspect 38: An apparatus comprising at least one means for performing a method of any of aspects 22 through 25.

Aspect 39: A non-transitory computer-readable medium storing code the code comprising instructions executable by a processor to perform a method of any of aspects 22 through 25.

Aspect 40: An apparatus for wireless communications at a base station, comprising a processor; memory coupled with the processor; and instructions stored in the memory and executable by the processor to cause the apparatus to perform a method of any of aspects 26 through 30.

Aspect 41: An apparatus for wireless communications at a base station, comprising at least one means for performing a method of any of aspects 26 through 30.

Aspect 42: A non-transitory computer-readable medium storing code for wireless communications at a base station, the code comprising instructions executable by a processor to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving signaling configuring one or more hopping patterns for a plurality of bandwidth parts, wherein each bandwidth part of the plurality of bandwidth parts comprises resource blocks having a bandwidth less than a threshold bandwidth support by the UE; and
transmitting, to a base station, control signaling indicating measurement gap information for a set of one or more radio frequency spectrum bands, wherein the control signaling indicates whether a measurement gap is applicable for performing one or more measurements of a signal based at least in part on the one or more hopping patterns and a frequency-domain location of the signal for the one or more measurements.

2. The method of claim 1, further comprising:
identifying hopping pattern identifiers for each hopping pattern of the one or more hopping patterns; and
generating a hopping pattern identifier list comprising the hopping pattern identifiers for each hopping pattern, wherein the measurement gap information comprises an indication of the hopping pattern identifier list.

3. The method of claim 1, further comprising:
identifying indices for one or more frequency hops associated with the one or more hopping patterns; and
generating a hop index list comprising the indices for the one or more frequency hops, wherein the measurement gap information comprises an indication of the hop index list.

4. The method of claim 1, further comprising:
identifying one or more hop region identifiers corresponding to respective frequency-domain regions that include hops associated with the one or more hopping patterns, each frequency-domain region of the respective frequency-domain regions comprising indices for one or more frequency hops; and
generating a hop region list comprising the one or more hop region identifiers, wherein the measurement gap information comprises an indication of the hop region list.

5. The method of claim 1, further comprising:
identifying a separation frequency between respective hops of the one or more hopping patterns, wherein the measurement gap information comprises an indication of the separation frequency between the respective hops.

6. The method of claim 1, further comprising:
determining, for the set of one or more radio frequency spectrum bands, whether the measurement gap is applicable for performing the one or more measurements, wherein the measurement gap information is based at least in part on the determination.

7. The method of claim 6, further comprising;
determining that the measurement gap is not applicable for the set of one or more radio frequency spectrum bands, wherein the measurement gap information comprises an indication that the measurement gap is not applicable based at least in part on the determination that the measurement gap is not applicable.

8. The method of claim 1, further comprising:
receiving the signal from the base station; and
performing the one or more measurements of the signal based at least in part on the measurement gap information.

9. The method of claim 1, wherein the control signaling includes one or more information elements comprising the measurement gap information.

10. The method of claim 1, wherein the one or more measurements comprise intra-frequency measurements of a synchronization signal block, and wherein the measurement gap information comprises intra-frequency measurement gap information.

11. The method of claim 1, wherein the one or more measurements comprise inter-frequency measurements of a synchronization signal block, and wherein the measurement gap information comprises inter-frequency measurement gap information.

12. The method of claim 1, wherein the one or more measurements comprise reference signal received power (RSRP) measurements, reference signal received quality (RSRQ) measurements, signal-to-interference plus noise ratio (SINK) measurements, or any combination thereof.

13. A method for wireless communication at a user equipment (UE), comprising:
receiving signaling that configures one or more hopping patterns for each bandwidth part of a plurality of bandwidth parts, wherein each bandwidth part of the plurality of bandwidth parts comprises resource blocks having a threshold bandwidth less than a bandwidth support by the UE;
determining a measurement gap pattern for an active bandwidth part based at least in part on an association between the measurement gap pattern and the active bandwidth part, or an association between the measurement gap pattern and a hopping pattern from the one or more hopping patterns for the active bandwidth part, or any combination thereof; and
performing measurements on one or more signals based at least in part on the determined measurement gap pattern.

14. The method of claim 13, further comprising:
identifying a hop duration associated with each of the one or more hopping patterns, wherein determining the measurement gap pattern is based at least in part on the association between the measurement gap pattern, or the active bandwidth part, or the hopping pattern for the active bandwidth part, or the hop duration, or any combination thereof.

15. The method of claim 13, wherein determining the measurement gap pattern comprises:
determining a first measurement gap pattern based at least in part on the active bandwidth part, the hopping pattern for the active bandwidth part, or any combination thereof;
receiving an indication that the active bandwidth part is being modified from a first bandwidth part to a second bandwidth part different from the first bandwidth part; and
determining a second measurement gap pattern based at least in part on the second bandwidth part, a second hopping pattern from the one or more hopping patterns for the second bandwidth part, or any combination thereof.

16. The method of claim 13, wherein determining the measurement gap pattern comprises:
determining a first measurement gap pattern based at least in part on the active bandwidth part, the hopping pattern for the active bandwidth part, or any combination thereof;
receiving an indication that the hopping pattern for the active bandwidth part is being modified from a first hopping pattern to a second hopping pattern different from the first hopping pattern; and
determining a second measurement gap pattern based at least in part on the second hopping pattern.

17. The method of claim 13, wherein determining the measurement gap pattern comprises:
receiving signaling disabling the hopping pattern for the active bandwidth part; and
determining a default measurement gap pattern based at least in part on the hopping pattern being disabled.

18. The method of claim 17, wherein the default measurement gap pattern is associated with the active bandwidth part.

19. The method of claim 17, further comprising:
receiving an indication that the hopping pattern for the active bandwidth part is being modified from a first hopping pattern to a second hopping pattern different from the first hopping pattern, the second hopping pattern being associated with disabled bandwidth part hopping, wherein the default measurement gap pattern is associated with the second hopping pattern.

20. The method of claim 13, further comprising:
identifying a measurement gap pattern identifier associated with the determined measurement gap pattern, wherein the measurement gap pattern identifier corresponds to a predetermined measurement gap pattern that excludes measurement gaps.

21. The method of claim 13, wherein determining the measurement gap pattern comprises:
determining the measurement gap pattern based at least in part on an absence of the association between the measurement gap pattern and the active bandwidth part, or the association between the measurement gap pattern and the hopping pattern from the one or more hopping patterns for the active bandwidth part, or any combination thereof, wherein the determined measurement gap pattern excludes measurement gaps.

22. A method for wireless communication at a base station comprising:
transmitting signaling configuring one or more hopping patterns for a plurality of bandwidth parts, wherein each bandwidth part of the plurality of bandwidth parts comprises resource blocks having a bandwidth less than a threshold bandwidth support by a user equipment (UE); and
receiving, from the UE, control signaling indicating measurement gap information for a set of one or more radio frequency spectrum bands, wherein the control signaling indicates whether a measurement gap is applicable for performing one or more measurements of a signal based at least in part on the one or more hopping patterns and a frequency-domain location of the signal for the one or more measurements.

23. The method of claim 22, wherein receiving the control signaling indicating the measurement gap information comprises:
receiving, as part of the measurement gap information, an indication of a hopping pattern identifier list comprising hopping pattern identifiers for each hopping pattern of the one or more hopping patterns.

24. The method of claim 22, wherein receiving the control signaling indicating the measurement gap information comprises:
receiving, as part of the measurement gap information, an indication of a hop index list comprising indices for one or more frequency hops associated with the one or more hopping patterns.

25. The method of claim 22, wherein receiving the control signaling indicating the measurement gap information comprises:
receiving, as part of the measurement gap information, an indication of a hop region list comprising one or more hop region identifiers corresponding to respective frequency-domain regions that include hops associated with the one or more hopping patterns, each frequency-domain region of the respective frequency-domain regions comprising indices for one or more frequency hops.

26. A method for wireless communication at a base station comprising:
transmitting signaling that configures one or more hopping patterns for each bandwidth part of a plurality of bandwidth parts, wherein each bandwidth part of the plurality of bandwidth parts comprises resource blocks having a threshold bandwidth less than a bandwidth support by a user equipment (UE); and
transmitting, to the UE, one or more signals based at least in part on an active bandwidth part and a measurement gap pattern, wherein the measurement gap pattern is based at least in part on an association between the measurement gap pattern and the active bandwidth part, or an association between the measurement gap pattern and a hopping pattern from the one or more hopping patterns for the active bandwidth part, or any combination thereof.

27. The method of claim 26, further comprising:
transmitting, to the UE, an indication that the active bandwidth part is being modified from a first bandwidth part to a second bandwidth part different from the first bandwidth part, wherein a second measurement gap pattern is based at least in part on the second bandwidth part, a second hopping pattern from the one or more hopping patterns for the second bandwidth part, or any combination thereof.

28. The method of claim 26, further comprising:
transmitting signaling disabling the hopping pattern for the active bandwidth part, wherein transmitting the one or more signals comprises:
transmitting the one or more signals based at least in part on a default measurement gap pattern that is associated with the hopping pattern being disabled.

29. The method of claim 28, wherein the default measurement gap pattern is associated with the active bandwidth part.

30. The method of claim 28, further comprising:
transmitting an indication that the hopping pattern for the active bandwidth part is being modified from a first hopping pattern to a second hopping pattern different from the first hopping pattern, the second hopping pattern associated with disabled bandwidth part hopping, wherein the default measurement gap pattern is associated with the second hopping pattern.
